(19) United States
(12) Patent Application Publication
(10) Pub. No.: US 2002/0123941 A1
(43) Pub. Date: Sep. 5, 2002

(54) Ordering system and method

(76) Inventors: Timothy O. Donahue, LaGrange, GA (US); Cynthia W. Thompson, Spartanburg, SC (US); Chad W. Gill, Greer, SC (US); Wright W. Furman, Inman, SC (US); George W. Sykes, Spartanburg, SC (US); James Blakeney Zemp, Warrington (GB)

Correspondence Address: Milliken & Company, P.O. Box 1927, Spartanburg, SC, 29304, US

(21) Appl. No.: 10/060,785

(22) Filed: Jan. 30, 2002

Related U.S. Application Data
(60) Provisional application No. 60/265,388, filed on Jan. 30, 2001.

(51) Int. Cl. G06F 17/60

(52) U.S. Cl. 705/26

(57) ABSTRACT

A floor covering related ordering system and method which enhances or replaces conventional floor covering sales or ordering techniques. In accordance with one embodiment, an ordering system and method utilizes one or more floor covering ordering websites which provide approved customers, potential customers, dealers, retailers, distributors, or users an eloquently simple means to review and evaluate current floor covering products, select particular designs or colors, order samples, order product, and the like.

### CROSS-REFERENCE TO RELATED APPLICATIONS

This application claims priority to and the benefit of prior filed U.S. Provisional Patent Application Serial No. 60/265,388, filed Jan. 30, 2001, hereby incorporated by reference herein.

### FIELD OF THE INVENTION

The present invention is directed to ordering systems and methods. More particularly, it is directed to an internet-based floor covering related ordering system and method wherein an approved dealer, distributor, or customer is able to select and order particular floor covering samples or products directly over the internet. Even more particularly, it is directed to a system including an on-line floor covering ordering website which facilitates the direct ordering of floor covering products or samples by approved dealers, distributors, or customers and corresponding production of such floor covering products or samples on demand with direct shipment to the dealer, distributor, or customer.

### BACKGROUND OF THE INVENTION

Conventional floor covering product ordering involves either a floor covering company salesperson, a dealer, a retailer, or a distributor who contacts a potential customer or existing dealer, a retailer, distributor, or customer regarding the sale of one or more floor covering products, such as carpet tile, broadloom carpet, area rugs, floor mats, or the like. When the customer makes an order, the salesperson, dealer, or distributor writes down the order and initializes order entry. This may involve the filling out of an invoice or a purchase order. The customer may have placed an order for one or more floor covering products or merely may have requested a sample of a particular floor covering product or products so they may evaluate the sample and determine if they want to make the purchase.

The initial order information, purchase order or invoice is forwarded from the dealer or distributor to the floor covering product company or is forwarded by the company salesperson to the sales department and/or other departments such as accounting, finance, and the warehouse or plant where typically, the order is filled out of inventory, packaged, and shipped.

Most floor covering companies sell a majority of their product out of inventory and do not make custom or special order products for their customers with short lead times. Hence, the customer or potential customer has a limited selection of floor covering offerings whether it be limited to particular designs, colors, substrates, and/or the like. For example, a particular company may only offer solid color floor covering in a tufted cut pile type carpet which is tufted with a particular natural or synthetic fiber or fiber blend.

Conventional floor covering product sales involves relatively high overhead and long lead times on the delivery of samples or products, offers a limited selection of products, may provide that orders can only be taken during normal business hours, and may only offer certain products in certain territories or regions.

For example, a particular floor covering product company may only have a salesforce in the United States of America, (not in Canada or Mexico) and may limit their product offering to just the United States of America as they do not have sufficient staff to service other countries or regions.

Hence, there is a need for an improved floor covering related ordering system and/or method such as a floor covering product and/or sample ordering system and/or method which either enhances or replaces conventional floor covering product or sample sales or ordering techniques.

### SUMMARY OF THE INVENTION

In accordance with the present invention, there is provided an improved ordering system and method which addresses the drawbacks of conventional product or sample sales or ordering and/or which can enhance or replace conventional product or sample sales or ordering techniques.

In accordance with one embodiment of the present invention, an ordering system and/or method utilizes one or more floor covering product and/or sample ordering websites which provide approved dealers, distributors, or customers an eloquently simple means to review and evaluate current floor covering products, select particular designs or colors, order samples, order product, and the like.

Also in accordance with the present invention potential ordering website users such as dealers, retailers, distributors, or customers can receive approval on-line to become approved floor covering product or sample customers who can order and receive samples and/or floor covering products.

In accordance with a particular example of the present invention, an existing or approved floor covering product and/or sample ordering party or user (dealer, distributor, or customer) accesses the floor covering ordering website which is available substantially 7 days a week, 24 hours a day and is accessible from substantially anywhere around the world via the internet or World Wide Web. The approved ordering party logs onto the website, enters their user id and password, and thereafter accesses and utilizes the website. For example, they can select a particular floor covering product type (carpet tile, broadloom, area rug, floor mat, or the like), select a particular substrate (cut pile tufted, loop pile tufted, cut and loop pile tufted, sisal like tufted, woven, bonded, non-woven, or the like), select a particular fiber type (natural, synthetic, or blend), select a particular design or pattern from an archive of hundreds or thousands of designs, select a particular color or background, select a particular size or length, select a particular quantity, view their selection on-line, order a sample, and/or order the selected floor covering product or products.

The selection lists (drop down boxes) for each category or criteria can be limited to items in inventory, items offered as current products, and/or custom or special menus.

Also, the floor covering ordering website allows for the user to select and order one or more products, select a particular shipping location and date, shows the amount for the order, bills the order, and the like.

In accordance with the present invention, when an approved user has entered an order, selected a shipping location, and has paid for the order (or selected a method of payment), this is transmitted to the product company and the ordered item or items is either selected out of inventory or produced on demand as a current offering or as a custom or special order which is then preferably direct shipped to the customer or location selected by the user.

In accordance with the present invention, particular orders can be shipped in 24 hours, 72 hours, 7 days, or 30 days depending on the floor covering products or samples ordered, the ship to location, whether the products can be taken from inventory or are produced on demand custom or special products, the method of payment, lead times, and the like.

In accordance with another example of the present invention, a prospective customer or user accesses the floor covering ordering website, enters the requested information to apply for clearance and approval to utilize the website as well as to validate the financial ability of the customer (or user). This is done almost instantaneously by accessing the potential customer's or user's credit report and assigning the potential customer or user a password and user id. If the potential customer or user is approved, they are able to log on to the website using their user id and password and can proceed with ordering floor covering products, samples, and/or the like. If the potential customer or user is not approved, they are denied access to further utilization of the website and are given a phone number, for example, a toll free phone number to call the company and attempt to become an approved customer, or can e-mail the company via a comment, “contact us” or e-mail facility of the website.

In accordance with the present invention, the floor covering product and/or sample customers (dealers, retailers, distributors, or customers) are benefited by the ability to order floor covering related products, samples, or the like substantially 7 days a week, 24 hours a day, 365 days a year from substantially any location in the world. Also the customer is able to select and view particular designs, patterns, colors, and the like. Also, the customer can order a sample and see the sample prior to making an order for product.

The floor covering company or companies that provide the samples and/or floor covering products are benefited in accordance with present invention by enhancing or replacing existing salesforces and overhead, reducing order entry and order delivery times, reducing inventory costs by only making products and samples which are ordered, can provide samples or products out of inventory when available, and do not have to inventory large quantities of stock which may reduce waste as a particular design or color which is not desirable to customers is not made and as such does not become waste material, sold on the seconds market, or the like.

One object of the present invention is the provision of an ordering system and/or method.

Another object of the present invention is the provision of a product and/or sample produced by the ordering system and/or method of the present invention.

Yet another object of the present invention is the provision of an internet (global internet, national internet, World Wide Web) product and/or sample ordering website (web site, home page, web page) which is a one stop website which facilitates creation and the taking of an order, the selection of a particular product and/or sample, and/or direct shipment of that order to the customer.

Still another object of the present invention is provision of a means for reducing or eliminating inventory, reducing or eliminating returns, reducing or eliminating salesforce overhead, reducing or eliminating the need for order data entry by the product offering company, and/or the like.

Still yet another object of the present invention is the provision of an ordering system and /or method which utilizes the world wide web or the global internet which allows for the expansion of the sales territory or region to substantially the entire globe or world without increasing salesforce overhead or the like.

Another more particular object of the present invention is the provision of a floor covering ordering website which allows a customer to select a particular floor covering product type, the design or pattern, the color or colors, the size, the quantity, and to either order a sample and/or product.

Still another object of present invention is the creation of an internet website which allows a customer limited access to certain company information (databases or selected fields in databases) such as floor covering product designs or patterns, colors, sizes, pricing, delivery dates or schedules, lead times, and the like.

In accordance with still another object of present invention, there is provided means for a customer or user to accomplish direct order entry, request direct shipment, and have products and/or samples either taken out of inventory or made or produced o n demand automatically when used in conjunction with automated inventory, production, packaging, and shipment systems, software, and/or the like.

Another object of present invention is to provide an ordering system and method which enhances the capabilities of on demand or custom or special order floor covering product production systems, machines, or the like such as a computer controlled jet dying machine which is capable of producing customers' on demand or special orders one right after the other as needed.

In accordance with the present invention there is provided an ordering system and method which allows for a totally automated floor covering product and/or sample ordering, production, and shipping process wherein a customer or user orders a product or sample, an automated machine produces the product or sample, automated machinery packages the product, and the product is direct shipped to the customer.

### BRIEF DESCRIPTION OF FIGURES

FIG. 1 is a schematic process flow diagram illustrating an ordering process or method in accordance with at least one embodiment of the present invention.

FIG. 2 is a schematic representation of an ordering system or method in accordance with at least one embodiment of the present invention.

FIGS. 3-11 are representations of selected screen displays which show the website in use and the sequence of method or process steps in accordance with one embodiment of the present invention.

FIG. 3 is a representation of a screen display used to gather user registration information.

FIG. 4 is a representation of a screen display showing selecting, editing, or viewing a pattern.

FIG. 5 is a representation of a screen display showing selecting, editing, or viewing a color.

FIG. 6 is a representation of a screen display showing an order and showing the selectable items of Product Type, Pattern, Color, Size, Quantity, and Side Mark.

FIG. 7 is a representation of a screen display showing selecting, editing, or viewing size.

FIG. 8 is a representation of a screen display showing viewing a selected pattern, color, etc.

FIG. 9 is a representation of a screen display showing selecting, editing or reviewing an item (Item #1).

FIG. 10 is a representation of a screen display showing selecting, editing, inputting, or viewing shipping and routing information (ship to location).

FIG. 11 is a representation of a screen display showing a quick claim form.

FIGS. 12-29 are representations of selected screen displays in accordance with another embodiment of the present invention.

FIG. 12 is a representation of a screen display used to log in by an authorized user (dealer, distributor, or customer).

FIG. 13 is a representation of a screen display showing starting a new order.

FIG. 14 is a representation of a screen display showing selecting a product type.

FIG. 15 is a representation of a screen display showing selecting a pattern.

FIG. 16 is a representation of a screen display showing selecting a color.

FIG. 17 is a representation of a screen display showing selecting a size.

FIG. 18 is a representation of a screen display showing a line item (product) ready to be added to the order.

FIG. 19 is a representation of a screen display showing the line item added to the order (shopping cart).

FIG. 20 is a representation of a screen display showing selecting or inputting shipping and routing information (ship to).

FIG. 21 is a representation of a screen display showing editing, viewing, deleting, or changing an order item.

FIG. 22 is a representation of a screen display showing an order with an item deleted (Item #1 deleted).

FIG. 23 is a representation of a screen display showing selecting a previous or saved order (existing order).

FIG. 24 is a representation of a screen display showing an existing order ready to be refreshed or completed.

FIG. 25 is a representation of a screen display showing promotional information.

FIG. 26 is a representation of a screen display showing “Contact Us” information and a comment/question box.

FIG. 27 is a representation of a screen display showing a quick claim form.

FIG. 28 is a representation of a screen display showing more of the quick claim form.

FIG. 29 is a representation of a screen display showing attaching a file to the quick claim form.

FIGS. 30-38 are representations of a website that allows a user to review selected products.

FIG. 30 is a representation of a screen display showing the Milliken® Sample Studio™ site selections.

FIG. 31 is a representation of a screen display showing Milliken® Sample Studio™ logging in.

FIG. 32 is a representation of a screen display showing checking for previous or current projects (none found).

FIG. 33 is a representation of a screen display showing selecting a collection.

FIG. 34 is a representation of a screen display showing selecting or viewing a design in the selected collection.

FIG. 35 is a representation of a screen display showing displaying or viewing a room scene with the selected collection or design.

FIG. 36 is a representation of a screen display showing various color choices or combinations of a selected design of a selected collection.

FIG. 37 is a representation of a screen display showing product specifications for a selected collection.

FIG. 38 is a representation of a screen display showing adding or selecting a particular design/pattern to a project folder, and showing the different sample selections.

FIGS. 39-42 are representations of general information which can be accessed via the website.

FIG. 39 is a representation of a screen display showing the first page of promotional or general information available on the site.

FIG. 40 is a representation of a screen display showing the second page of promotional or general information available on the site.

FIG. 41 is a representation of a screen display showing the third page of promotional or general information available on the site.

FIG. 42 is a representation of a screen display showing the fourth page of promotional or general information available on the site.

### DETAILED DESCRIPTION OF PRESENT INVENTION

In accordance with at least one embodiment of the present invention, there is provided an improved ordering system and method which addresses the drawbacks of conventional product or sample sales or ordering and/or which can enhance or replace conventional product or sample sales or ordering techniques.

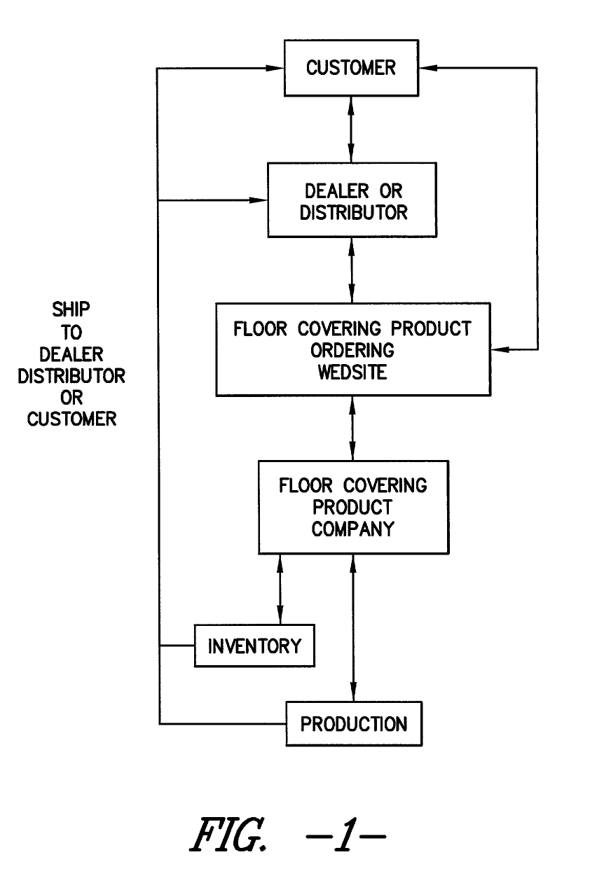

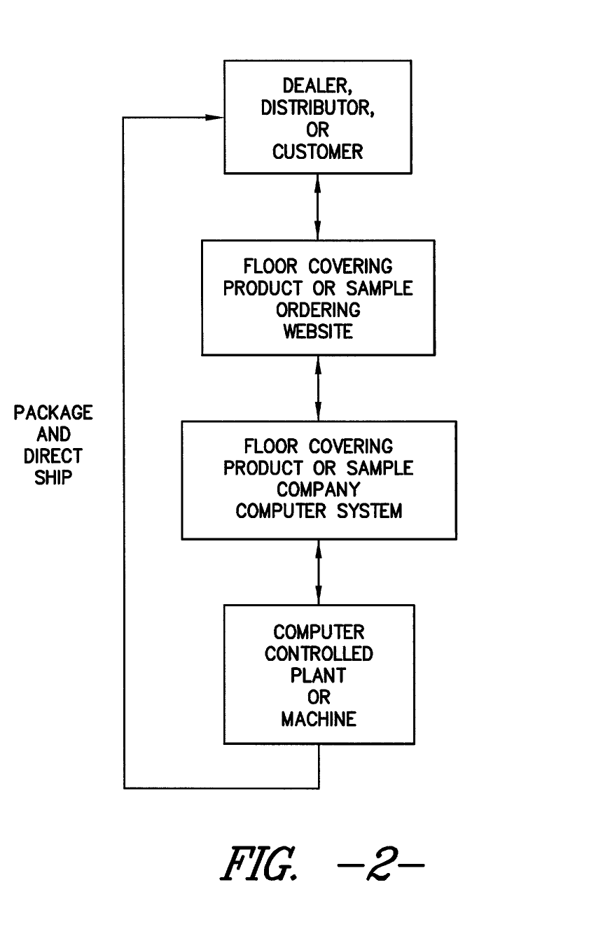

With reference to FIGS. 1 and 2 and in accordance with at least one embodiment of the present invention, an ordering system and/or method utilizes one or more floor covering product and/or sample ordering websites which provide approved dealers, retailers, distributors, or customers (users) an eloquently simple means to review and evaluate current floor covering products, select particular designs or colors, order samples, order product, and the like.

With reference to FIGS. 1, 2 and 3, and in accordance with at least one embodiment of the present invention, potential ordering website users such as dealers, distributors, or customers can receive approval on-line to become approved floor covering product or sample customers who can order and receive samples and/or floor covering products.

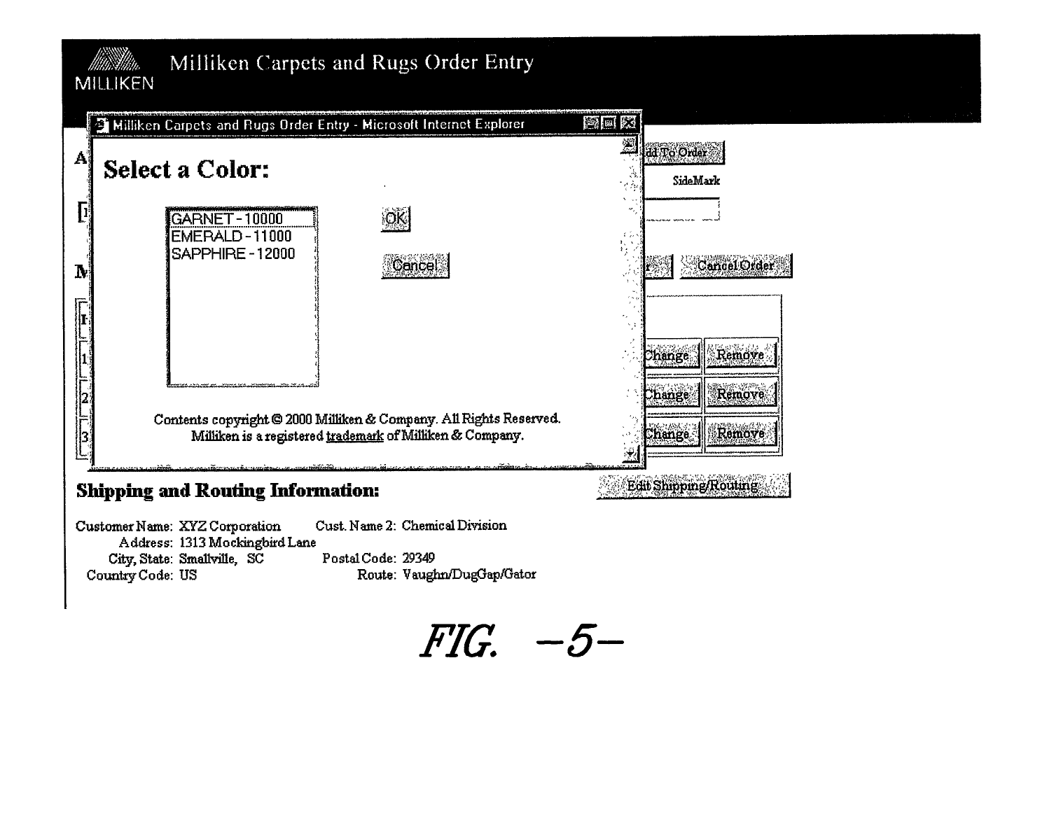

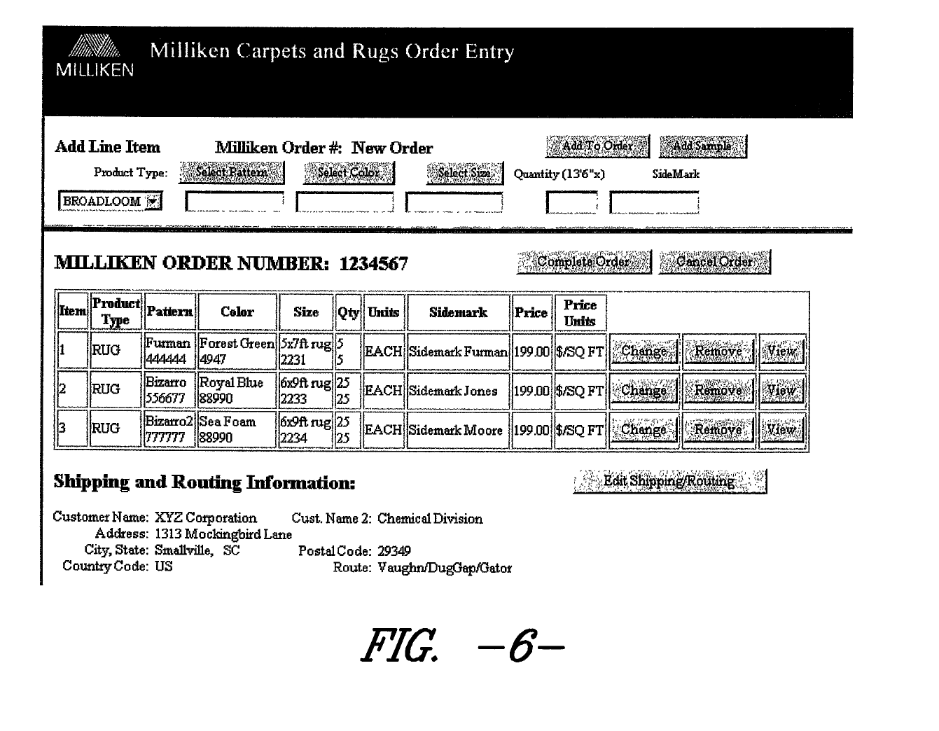

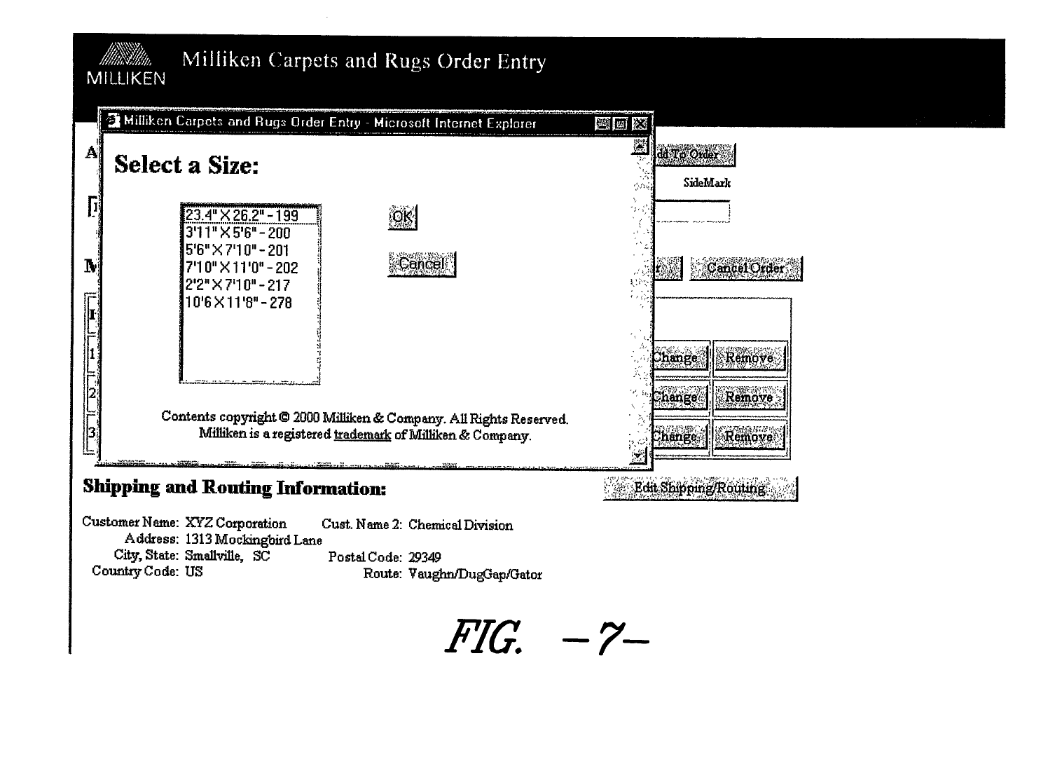

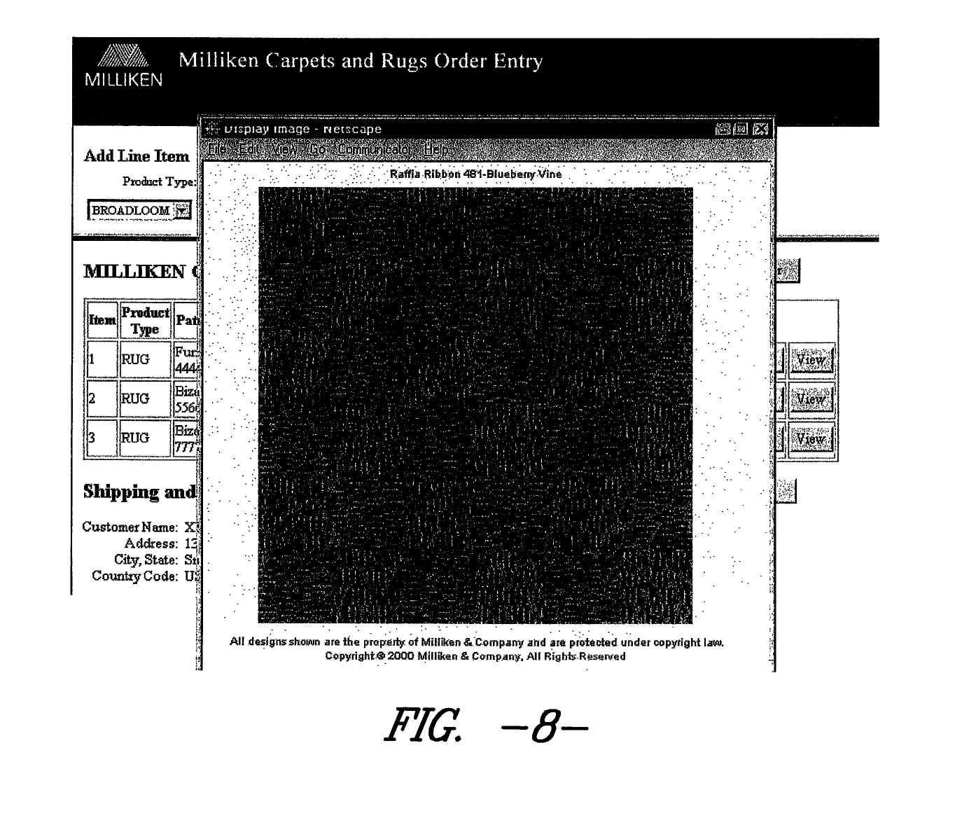

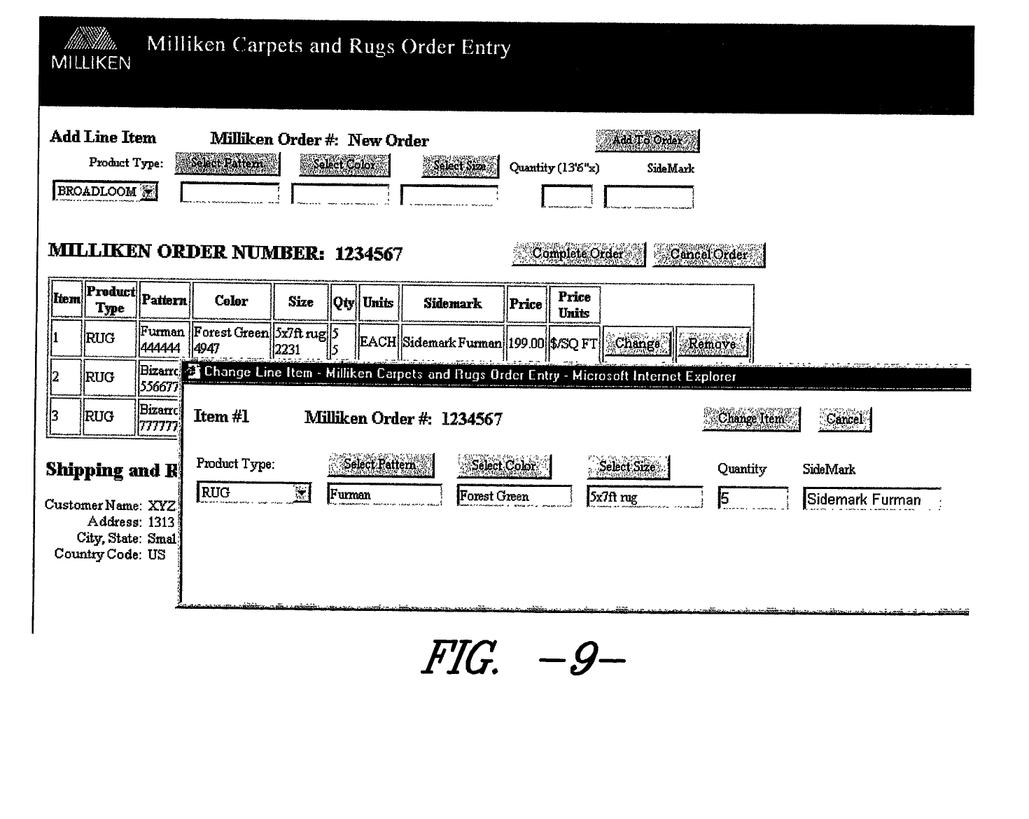

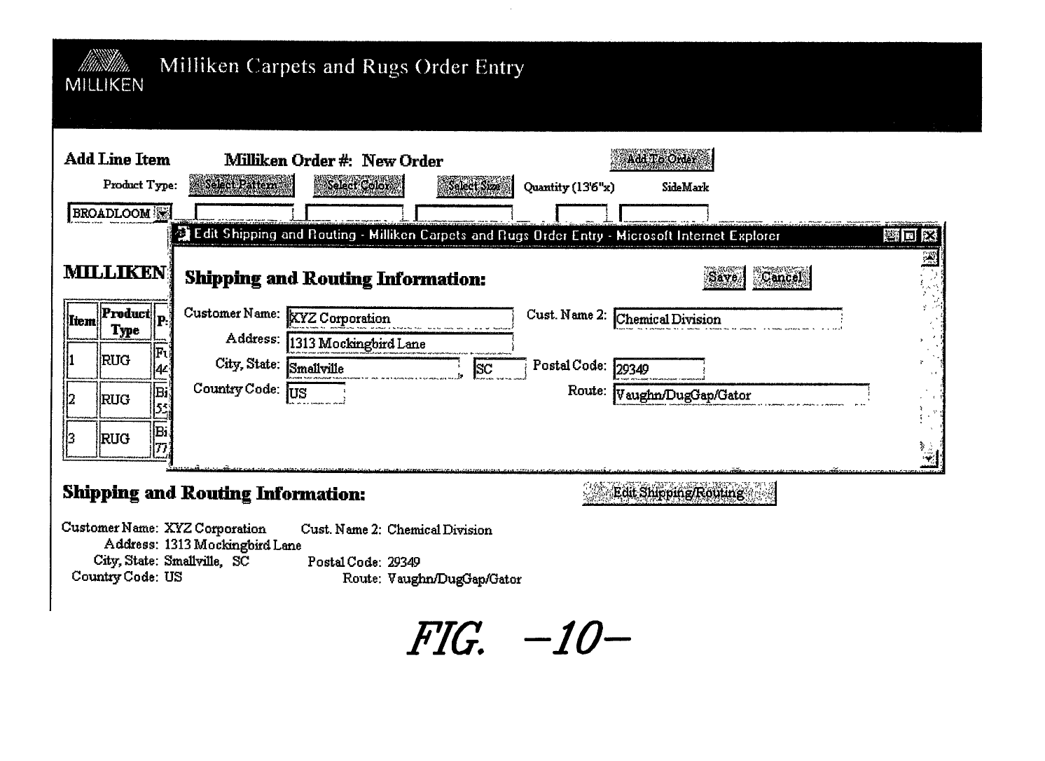

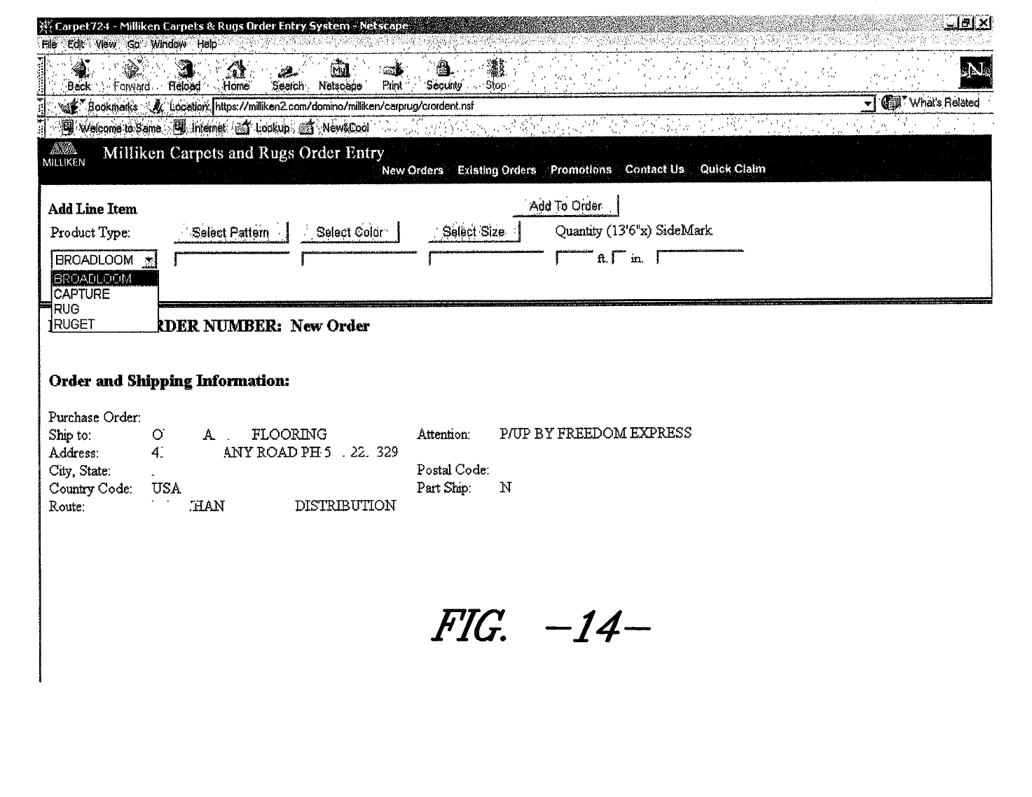

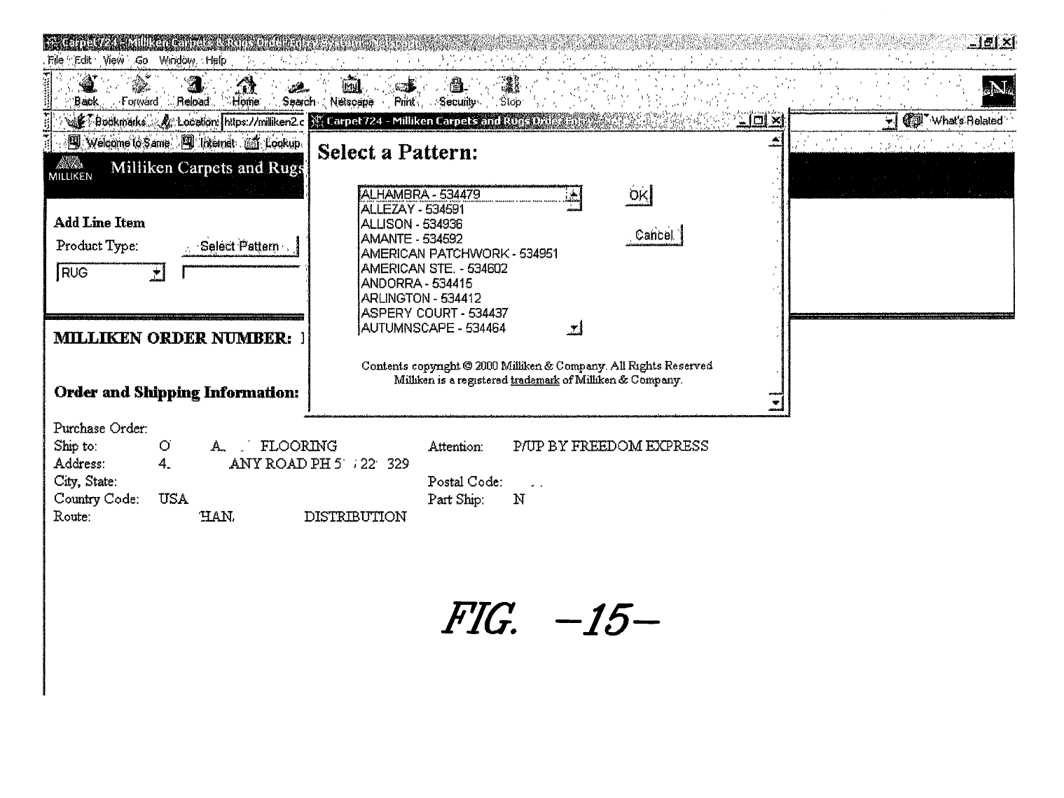

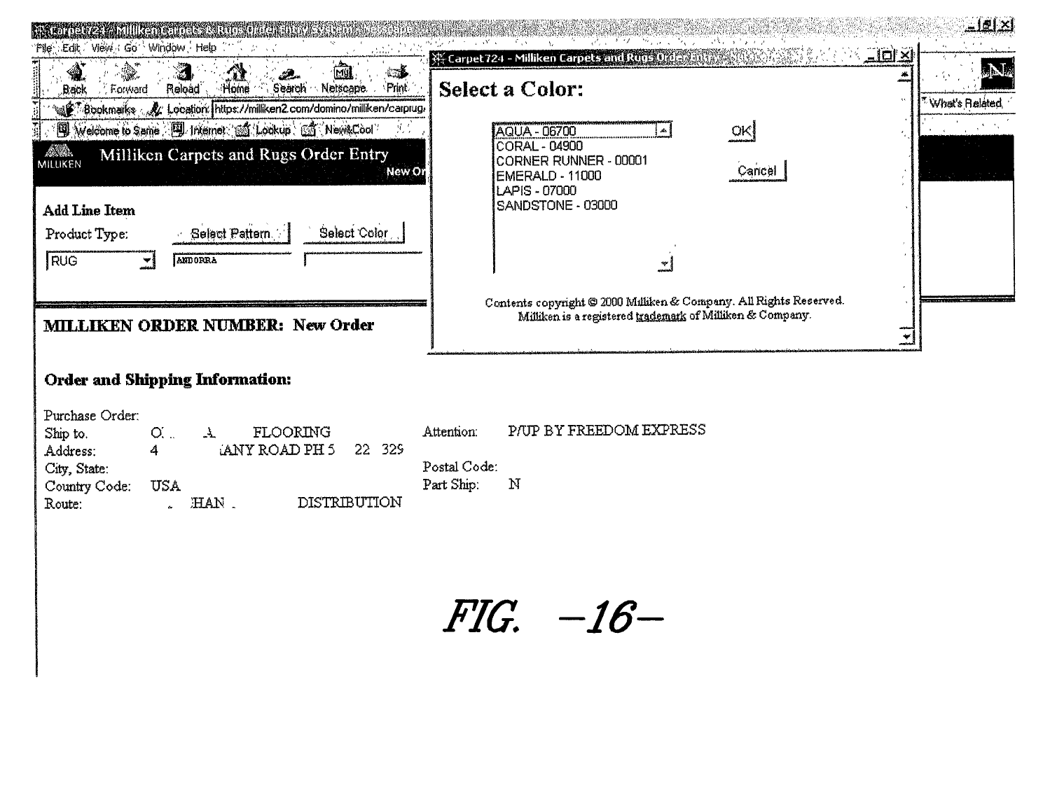

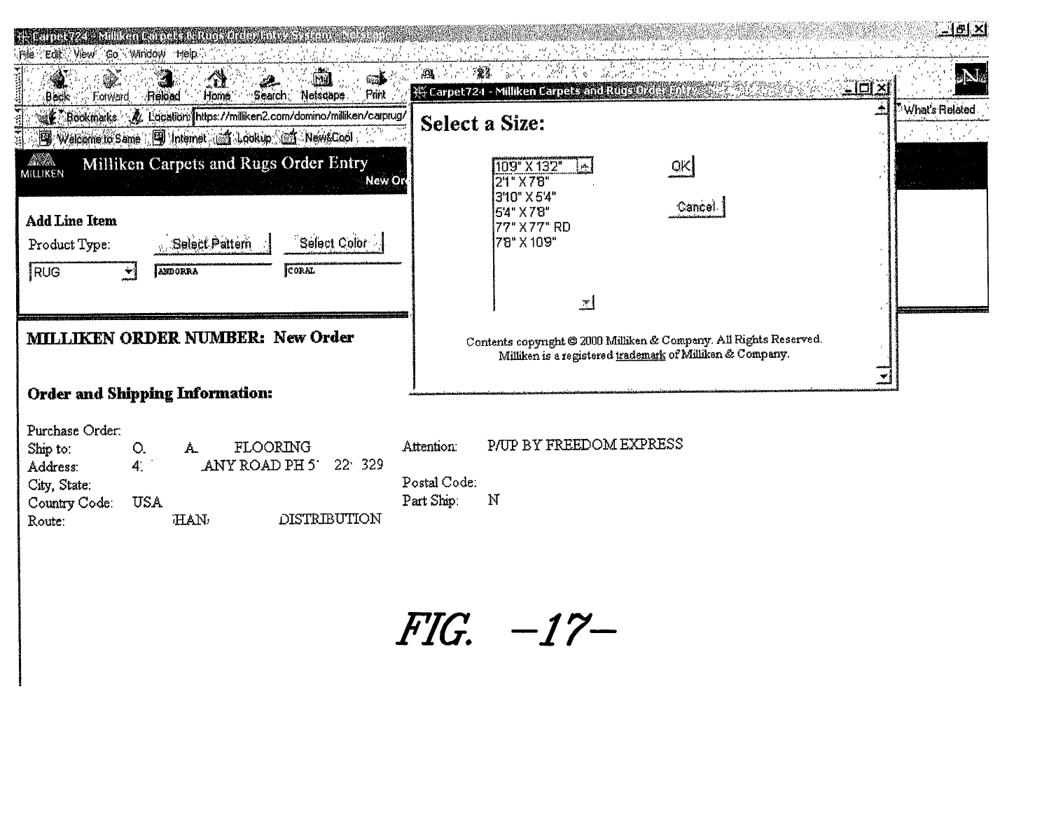

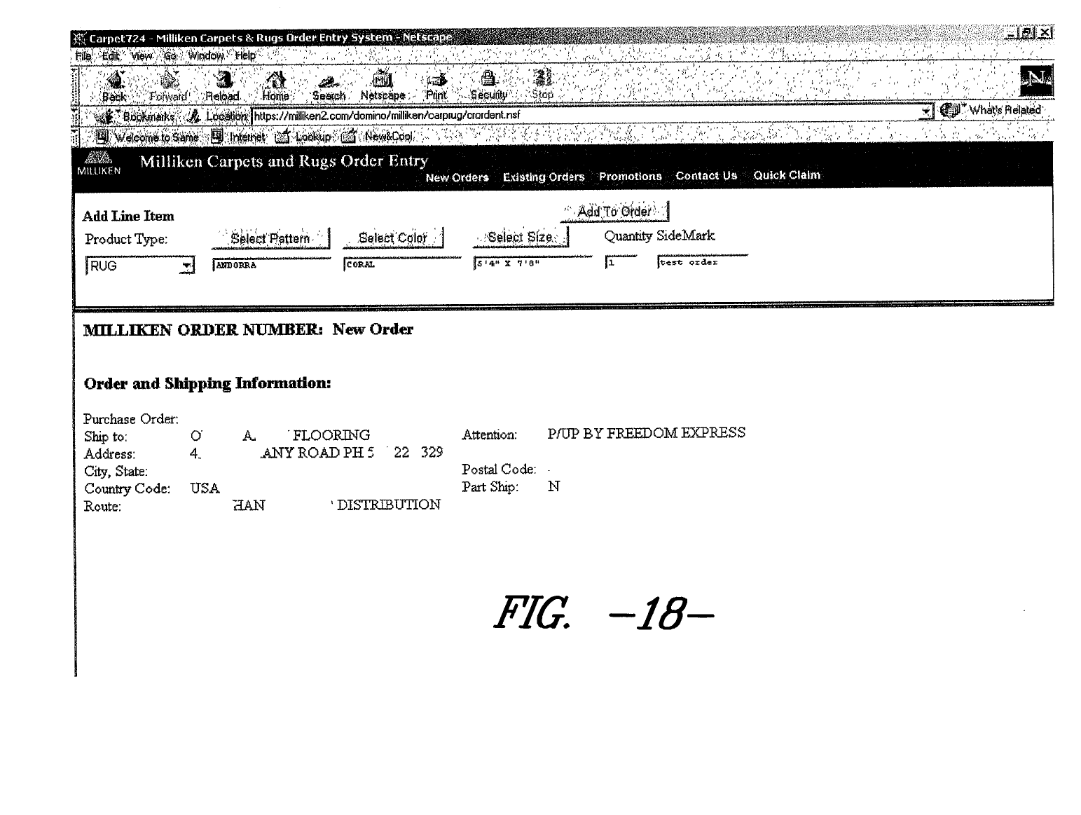

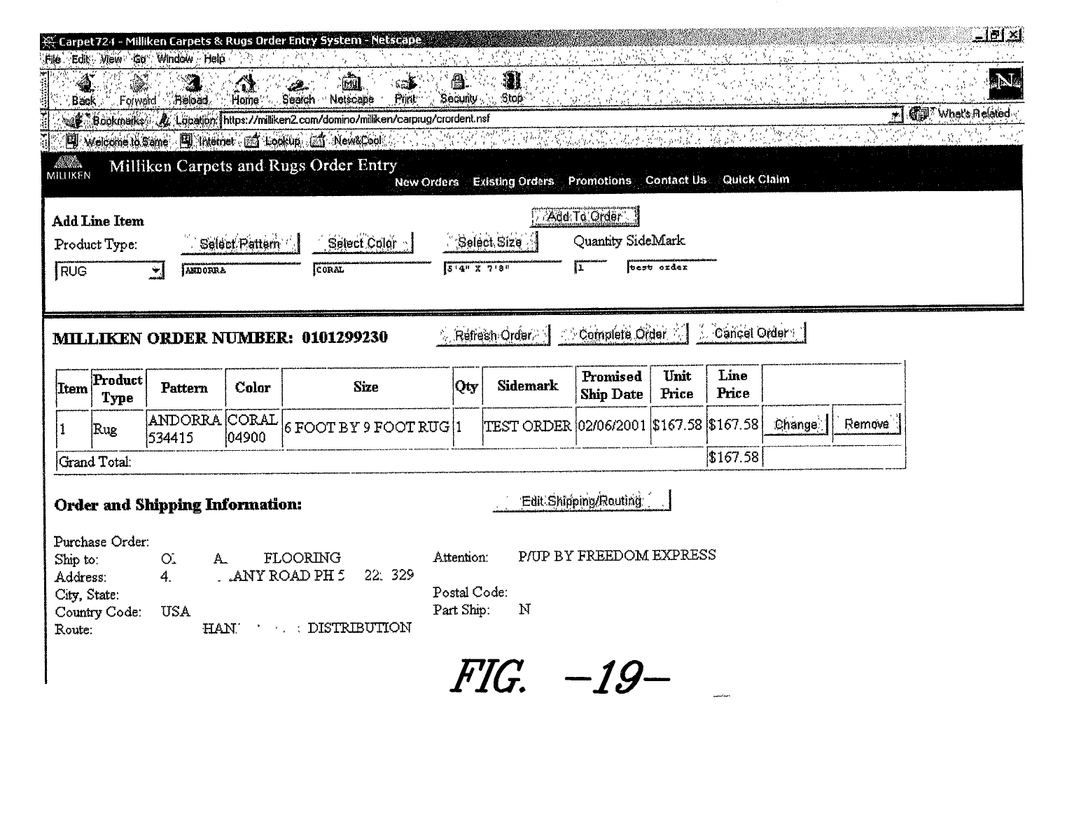

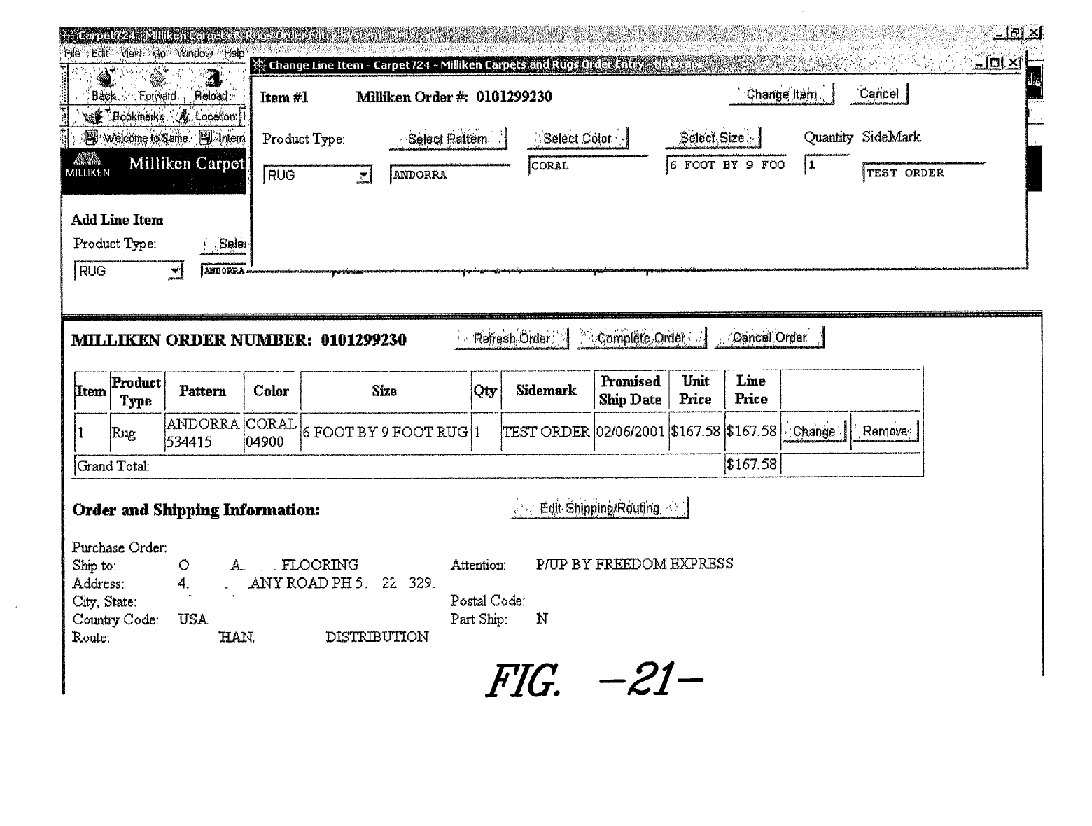

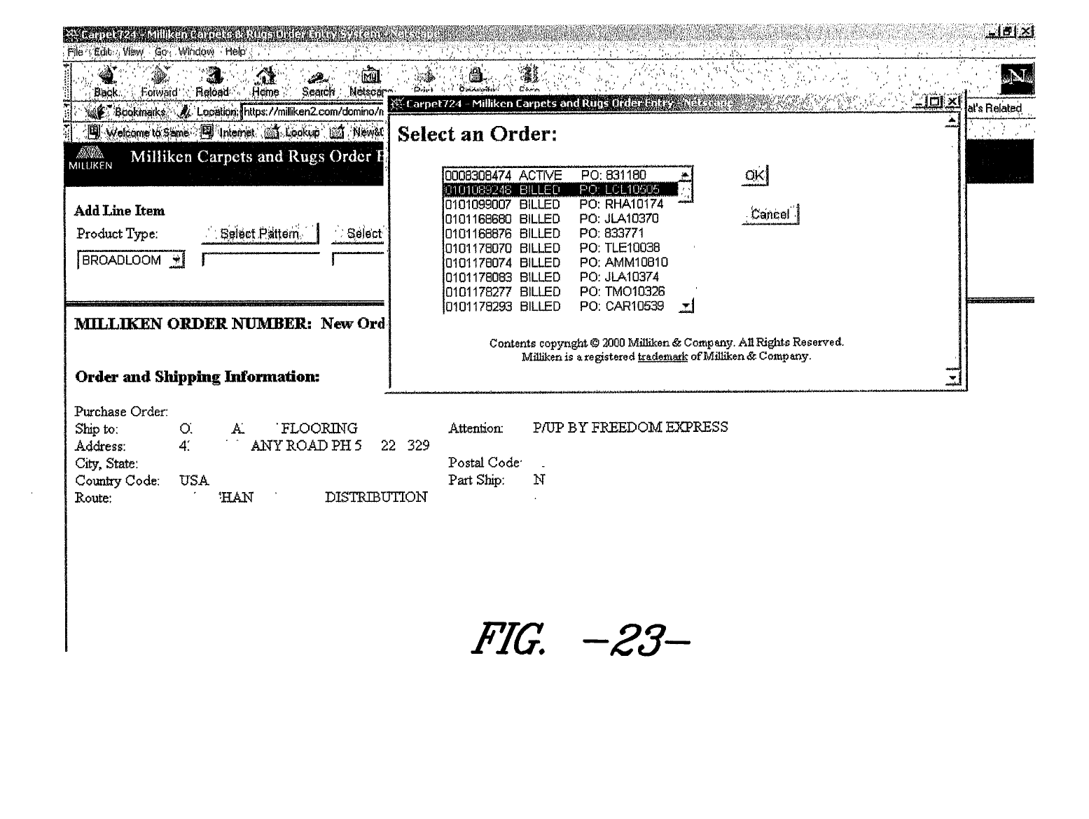

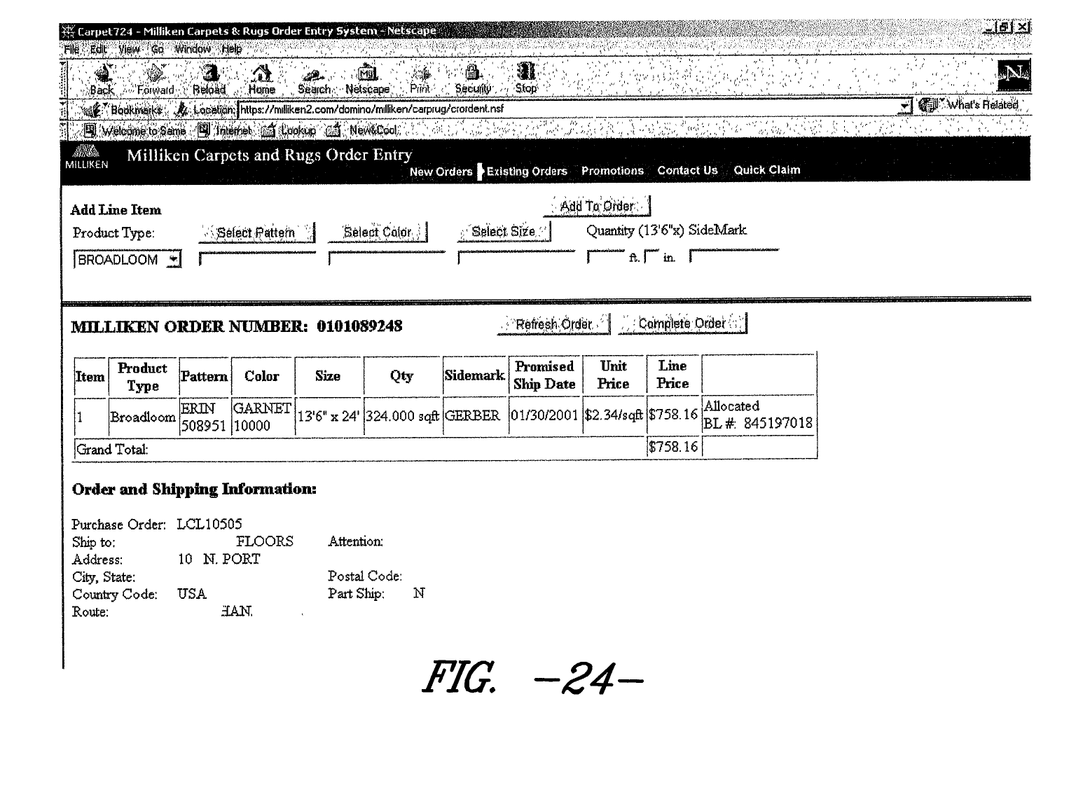

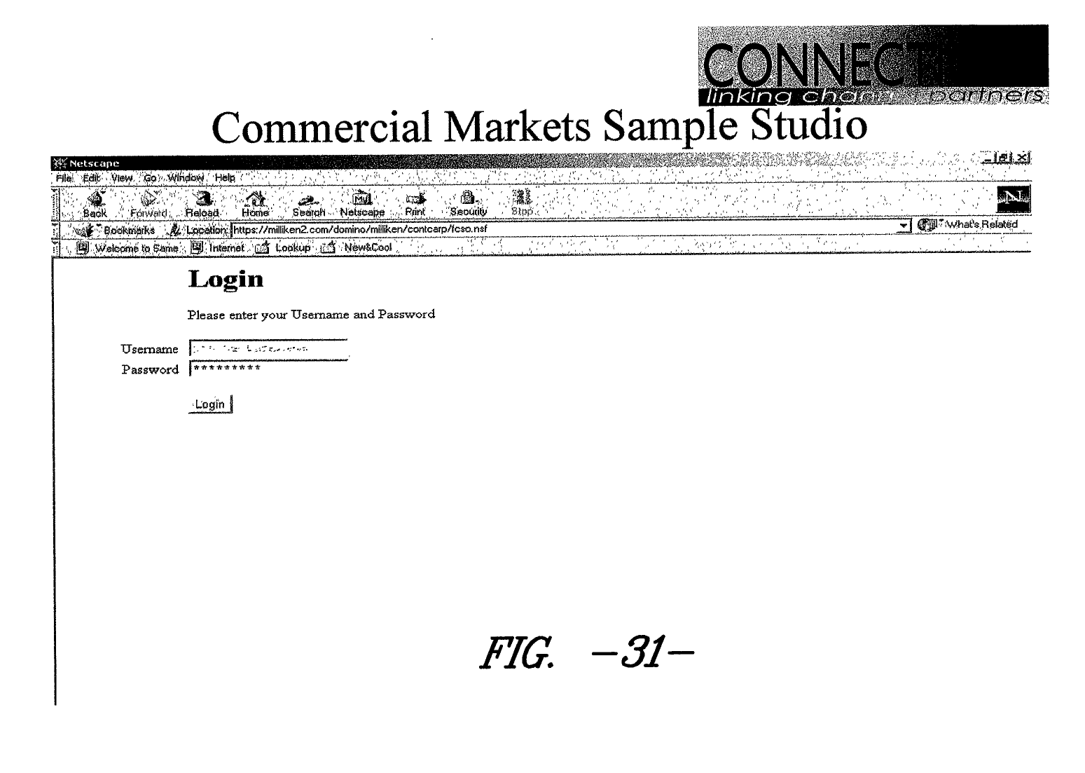

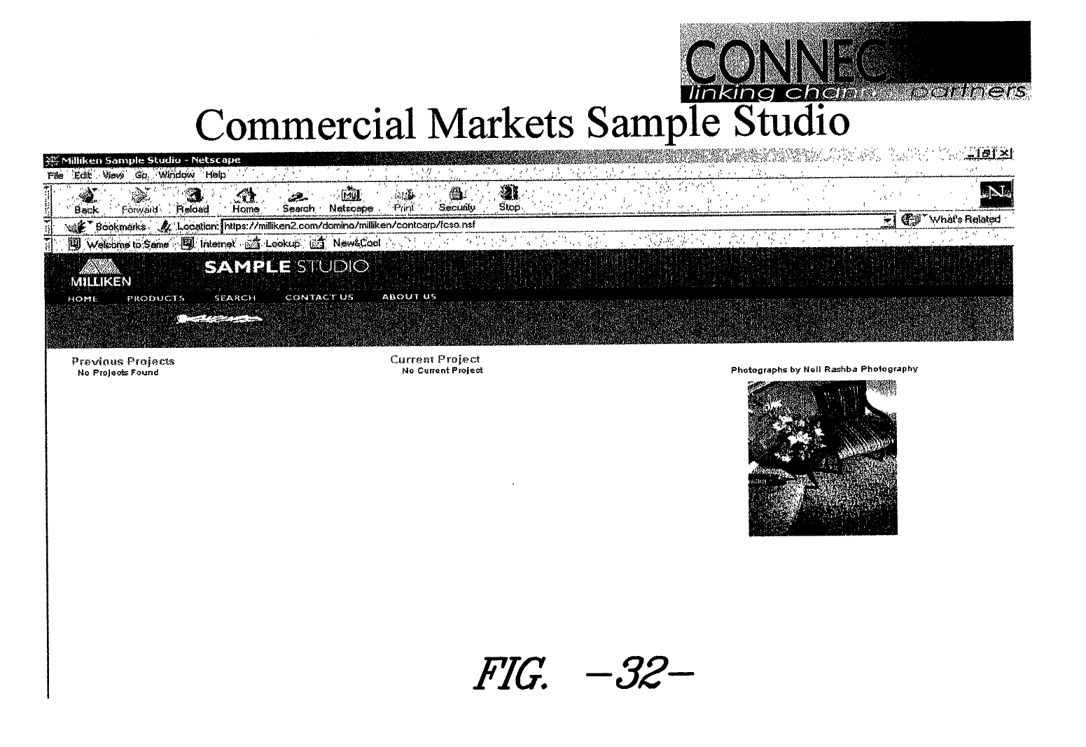

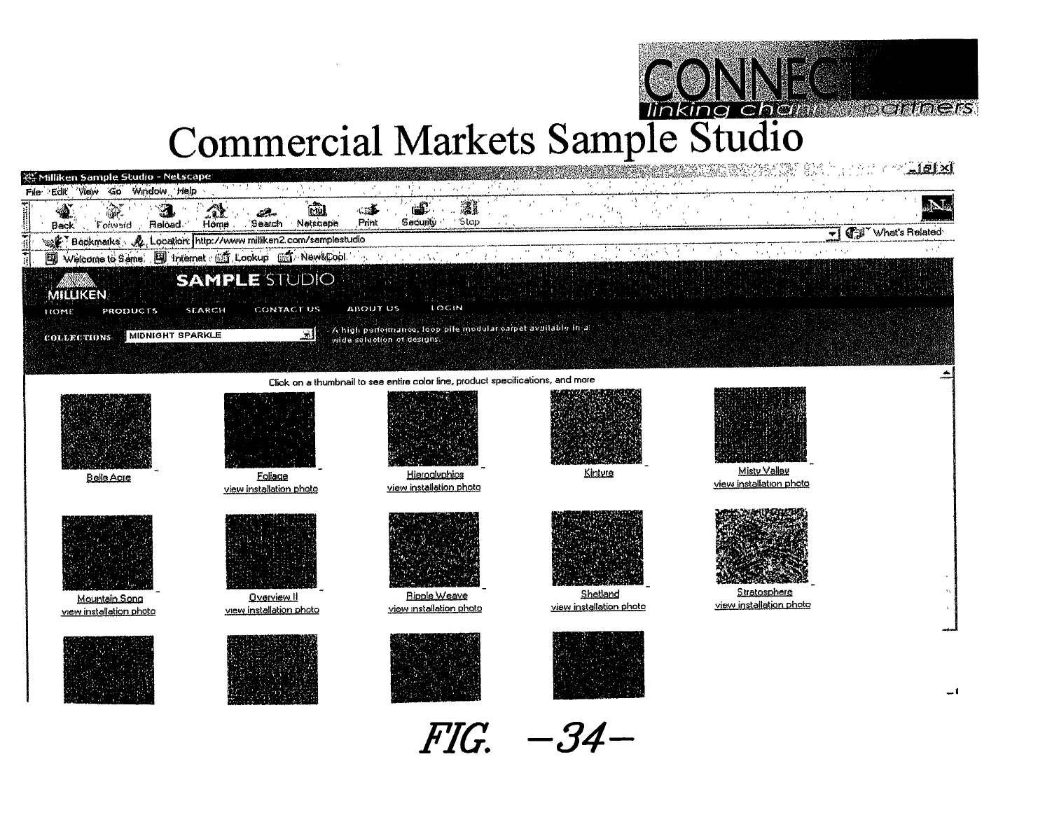

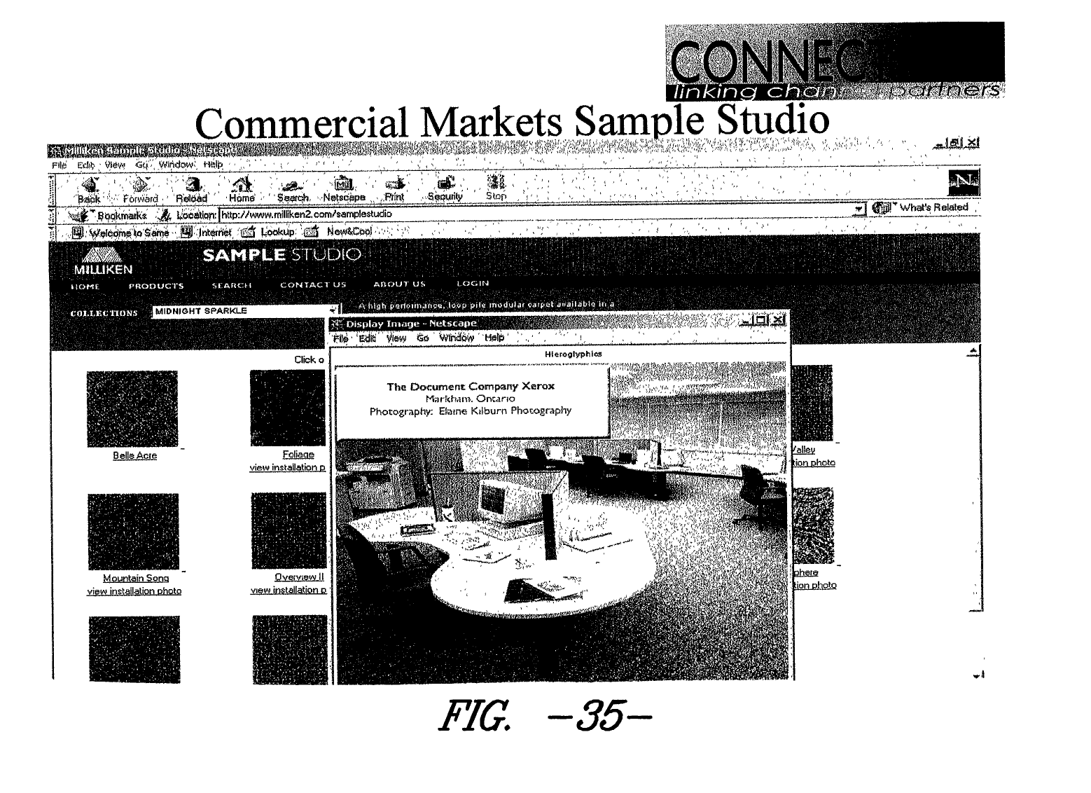

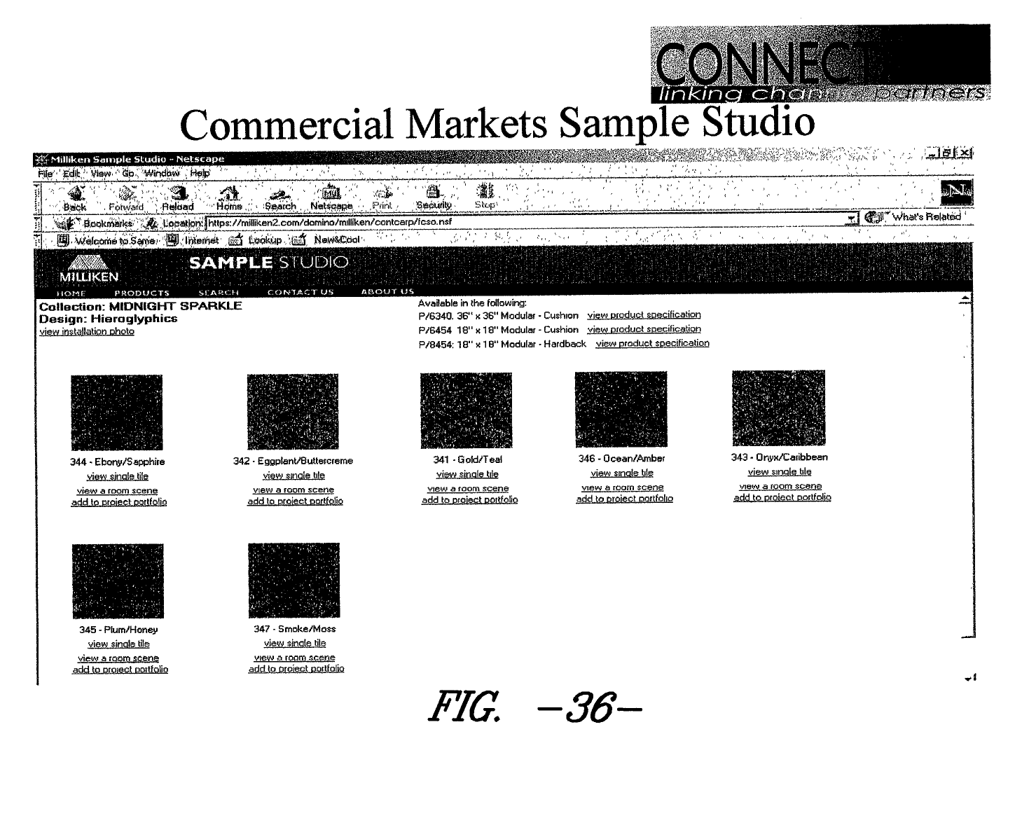

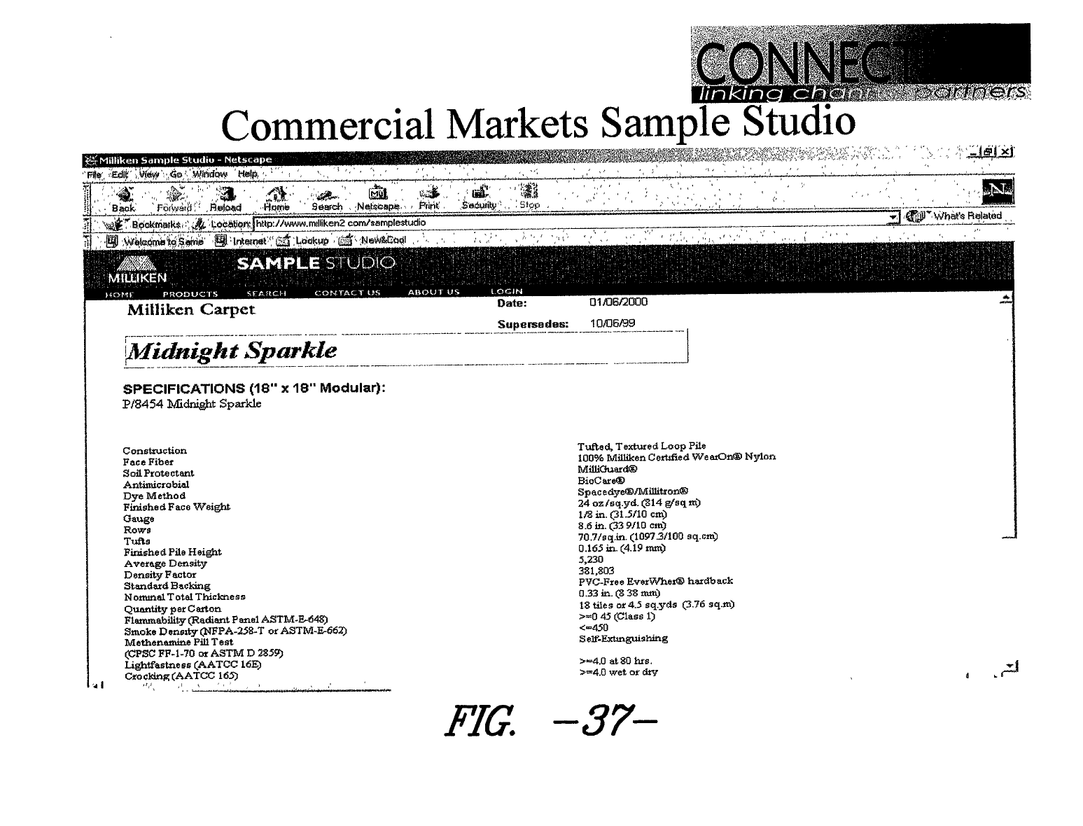

With reference to FIGS. 1, 2, 4-10, 12-24, and 30-38, and in accordance with at least one particular example of the present invention, an existing or approved floor covering product and/or sample ordering party or user (dealer, distributor, or customer) accesses the floor covering ordering website which is available substantially 7 days a week, 24 hours a day, 365 days a year, and is accessible from substantially anywhere around the world via the internet or World Wide Web (WWW). The approved ordering party logs onto the website, enters their user id and password, and thereafter accesses and utilizes the website. For example, they can select a particular floor covering product type (carpet tile, broadloom, area rug, floor mat, or the like), select a particular substrate (cut pile tufted, loop pile tufted, cut and loop pile tufted, sisal like tufted, woven, bonded, non-woven, or the like), select a particular fiber type (natural, synthetic, or blend), select a particular design or pattern from an archive of hundreds of thousands of designs, select a particular color or background, select a particular size or length, select a particular quantity, view their selection on-line, order a sample, and/or order the selected floor covering product or products.

The selection lists (drop down boxes) for each category or criteria can be limited to items in inventory, items offered as current products, and/or custom or special menus.

Also, the floor covering ordering website allows for the user to select and order one or more products, select a particular shipping location and date, shows the amount for the order, bills the order, and the like.

With reference again to FIG. 1 and in accordance with at least one embodiment of the present invention, when an approved user has entered an order, selected a shipping location, and has paid for the order (or selected a method of payment), this is transmitted to the product company and the ordered item or items is either selected out of inventory or produced on demand as a current offering or as a custom or special order which is then preferably direct shipped to the customer or location selected by the user.

In accordance with the present invention, particular orders can be shipped within 24 hours, 72 hours, 7 days, or 30 days of the order depending on the one or more floor covering products or samples ordered, the ship to location, whether the products can be taken from inventory or are produced on demand custom or special products, the method of payment, lead times, and the like.

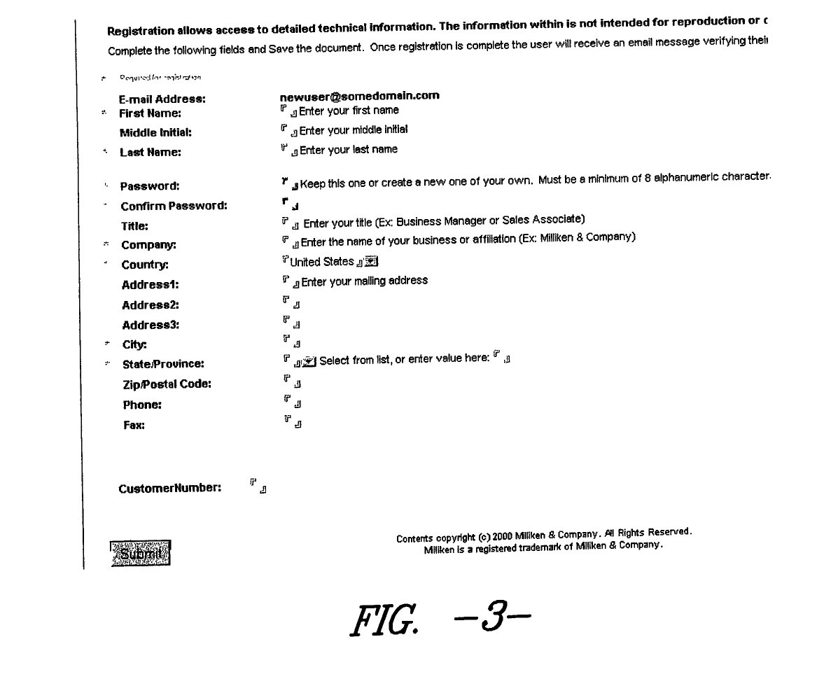

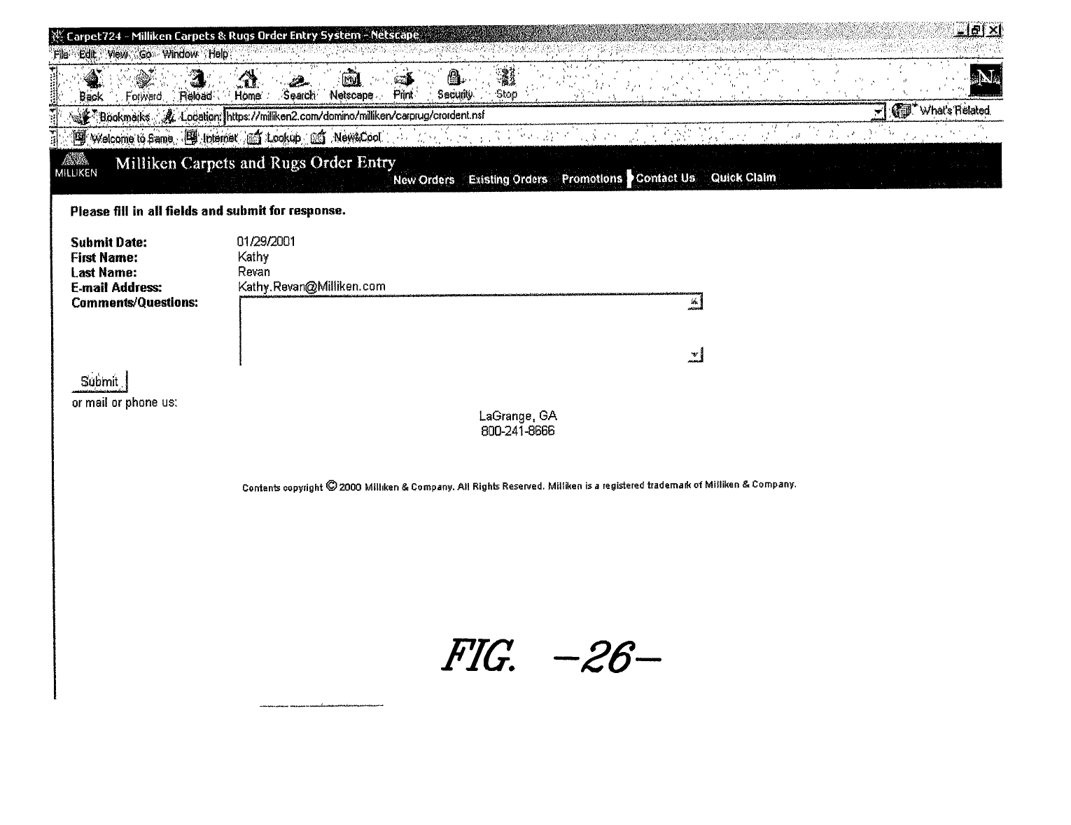

With reference to FIGS. 3 and 26, and in accordance with another example of the present invention, a prospective customer or user accesses the floor covering ordering website, enters the requested information to apply for clearance and approval to utilize the website as well as to validate the financial ability of the customer (or user). This is done almost instantaneously by accessing the potential customer's or user's credit report and assigning the potential customer or user a password and user id. If the potential customer or user is approved, they are able to log on to the website using their user id and password and can proceed with ordering floor covering products, samples, and/or the like. If the potential customer or user is not approved, they are denied access to further utilization of the website and are given a phone number, for example, a toll free phone number to call the company and attempt to become an approved customer, or can e-mail the company via a comment, “contact us” or e-mail facility of the website.

In accordance with the present invention, the floor covering product and/or sample customers (dealers, retailers, distributors, or customers) are benefited by the ability to order floor covering related products, samples, or the like substantially 7 days a week, 24 hours a day, from substantially any location in the world. Also the customer is able to select and view particular designs, patterns, colors, and the like. Also, the customer can order a sample and see the sample prior to making an order for product.

The floor covering company or companies that provide the samples and/or floor covering products are benefited in accordance with the present invention by enhancing or replacing existing sales forces and overhead, reducing order entry and order delivery times, reducing inventory costs by only making products and samples which are ordered, can provide samples or products out of inventory when available, and do not have to inventory large quantities of stock which may reduce waste as a particular design or color which is not desirable to customers is not made and as such does not become waste material, sold on the seconds market, or the like.

At least one embodiment of the present invention is directed to an ordering system and/or method.

At least one embodiment of the present invention is directed to a product and/or sample produced by the ordering system and/or method of the present invention.

At least one embodiment of the present invention is directed to an internet (global internet, national internet, World Wide Web) product and/or sample ordering website (web site, home page, web page) which is a one stop website which facilitates creation and the taking of an order, the selection of a particular product and/or sample, and/or direct shipment of that order to the customer.

At least one embodiment of the present invention is directed to a means for reducing or eliminating inventory, reducing or eliminating returns, reducing or eliminating sales force overhead, reducing or eliminating the need for order data entry by the product offering company, and/or the like.

At least one embodiment of the present invention is directed to an ordering system and/or method which utilizes the world wide web or the global internet which allows for the expansion of the sales territory or region to substantially the entire globe or world without increasing sales force overhead or the like.

At least one embodiment of the present invention is directed to a floor covering ordering website which allows a customer to select a particular floor covering product type, the design or pattern, the color or colors, the size, the quantity, and to either order a sample and/or product.

At least one embodiment of present invention is directed to an internet website which allows a customer limited access to certain company information (databases or selected fields in databases) such as floor covering product designs or patterns, colors, sizes, pricing, delivery dates or schedules, lead times, and the like.

At least one embodiment of present invention is directed to means for a customer or user to accomplish direct order entry, request direct shipment, and have products and/or samples either taken out of inventory or made or produced on demand automatically when used in conjunction with automated inventory, production, packaging, and shipment systems, software, and/or the like.

At least one embodiment of present invention is directed to an ordering system and method which enhances the capabilities of on demand or custom or special order floor covering product production systems, machines, or the like such as a computer controlled jet dying machine which is capable of producing customers' on demand or special orders one right after the other as needed.

At least one embodiment of the present invention there is directed to an ordering system and method which allows for a totally automated floor covering product and/or sample ordering, production, and shipping process wherein a customer or user orders a product or sample, an automated machine produces the product or sample, automated machinery packages the product, and the product is direct shipped to the customer.

FIG. 3 shows a schematic screen-shot or screen display of the website screen used to gather user registration information. Items marked with an asterisk are required.

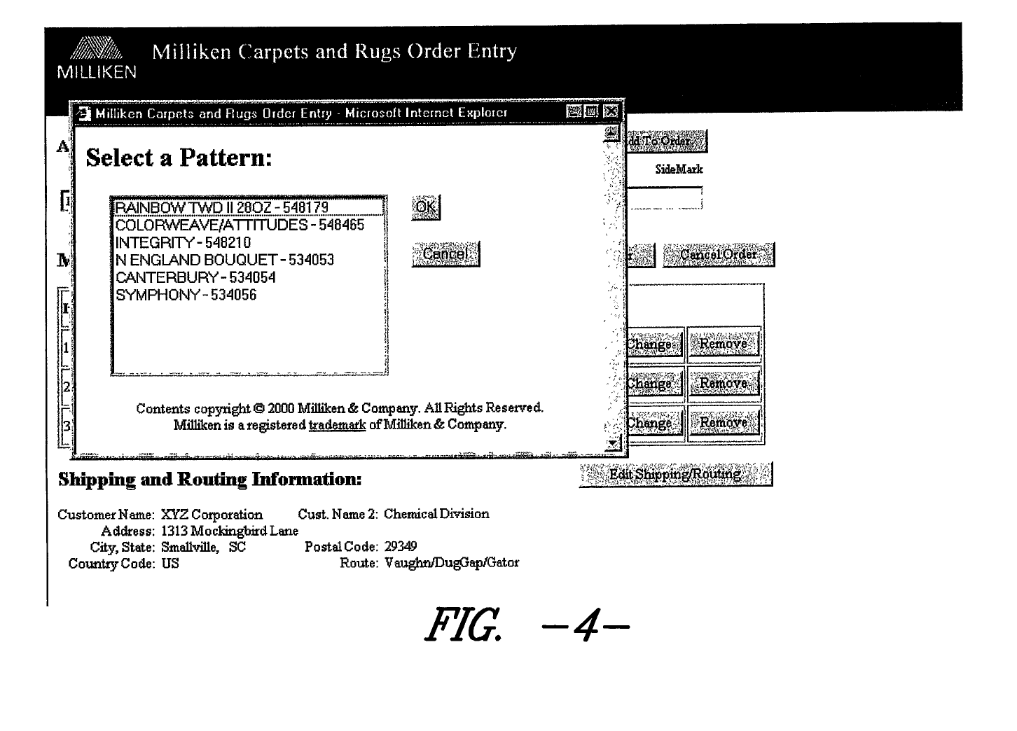

The website of FIGS. 4-11 provides for the selection of product type, pattern, color, size, quantity, side mark, and ship to and routing location, as well as review of and purchase of one or more products and/or samples.

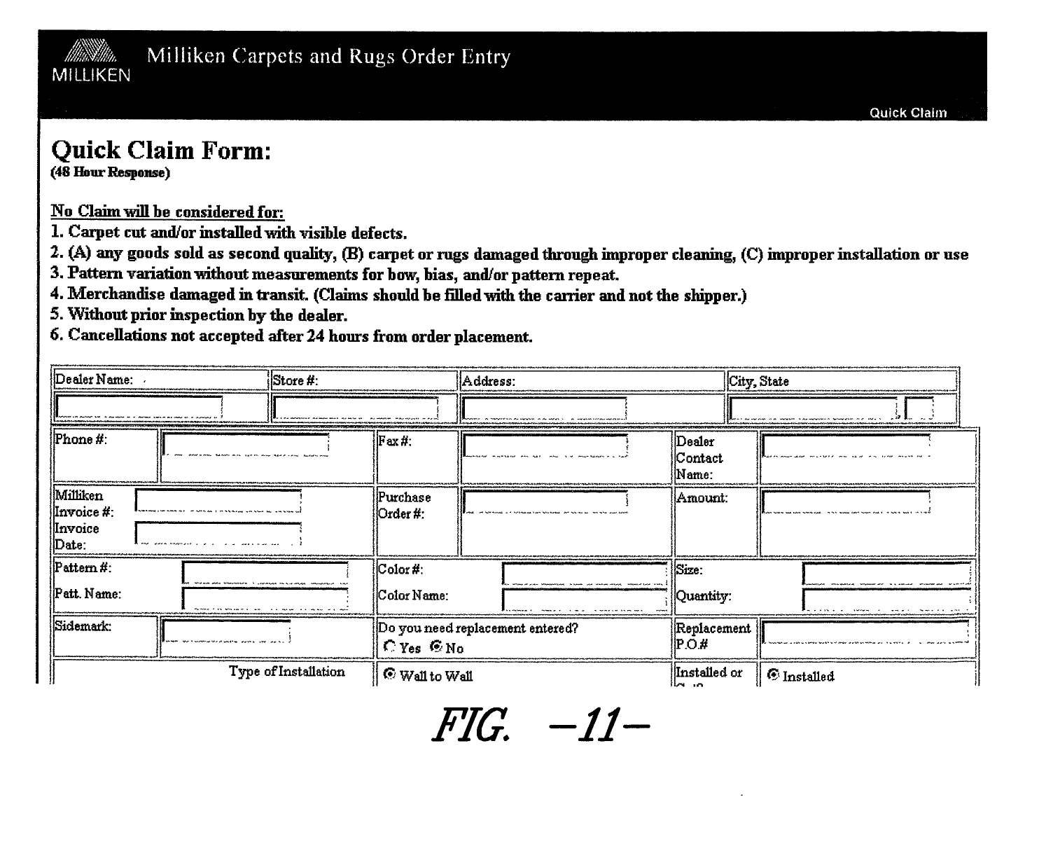

With reference to FIG. 11, the website also provides for the making of a claim, making an order, reviewing past orders, viewing promotional information, and contacting the company.

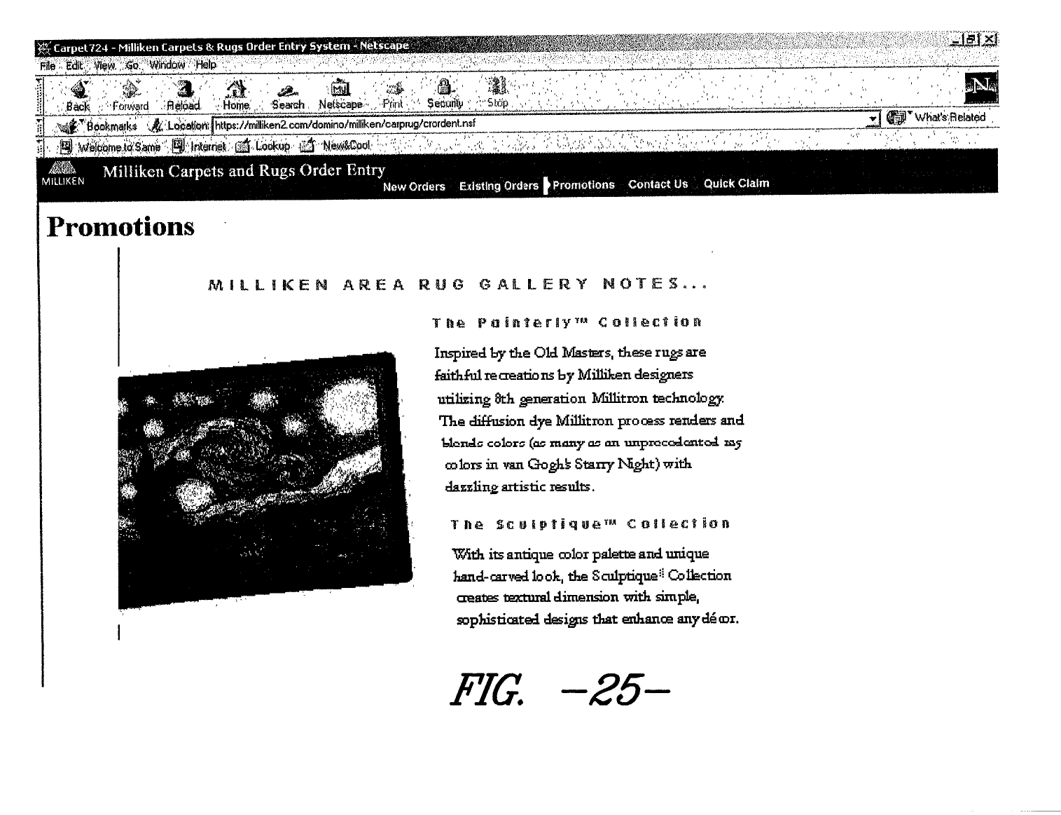

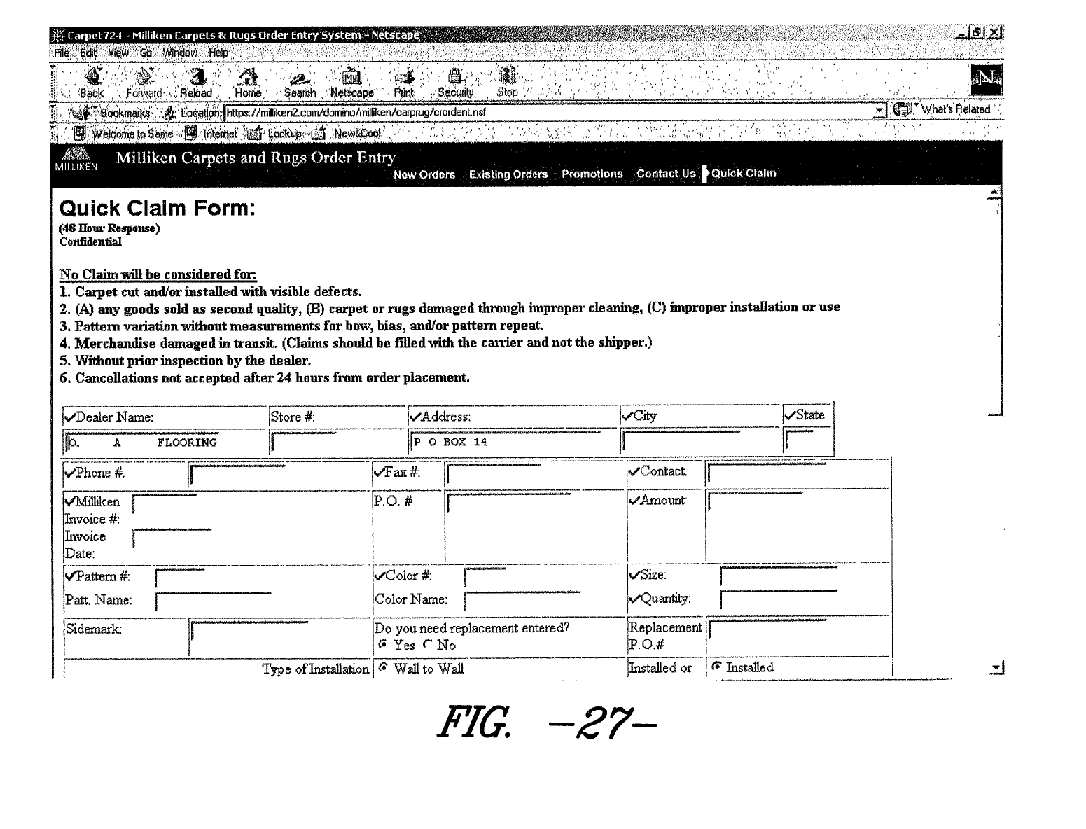

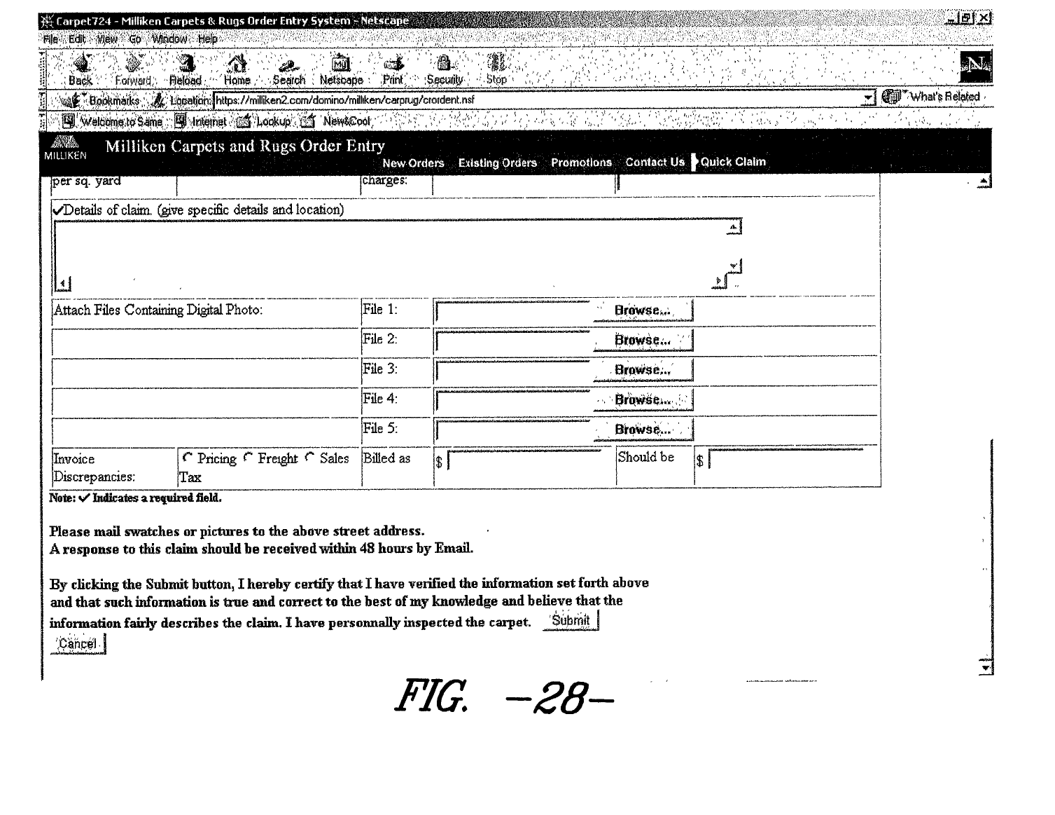

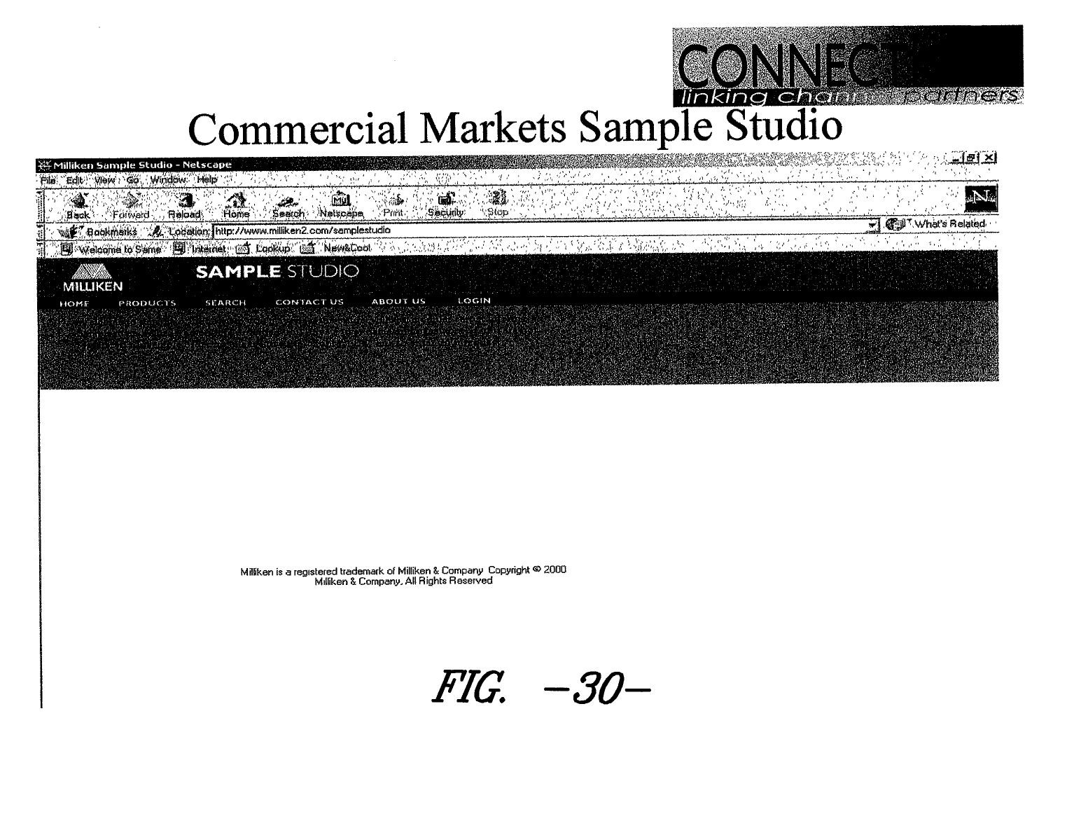

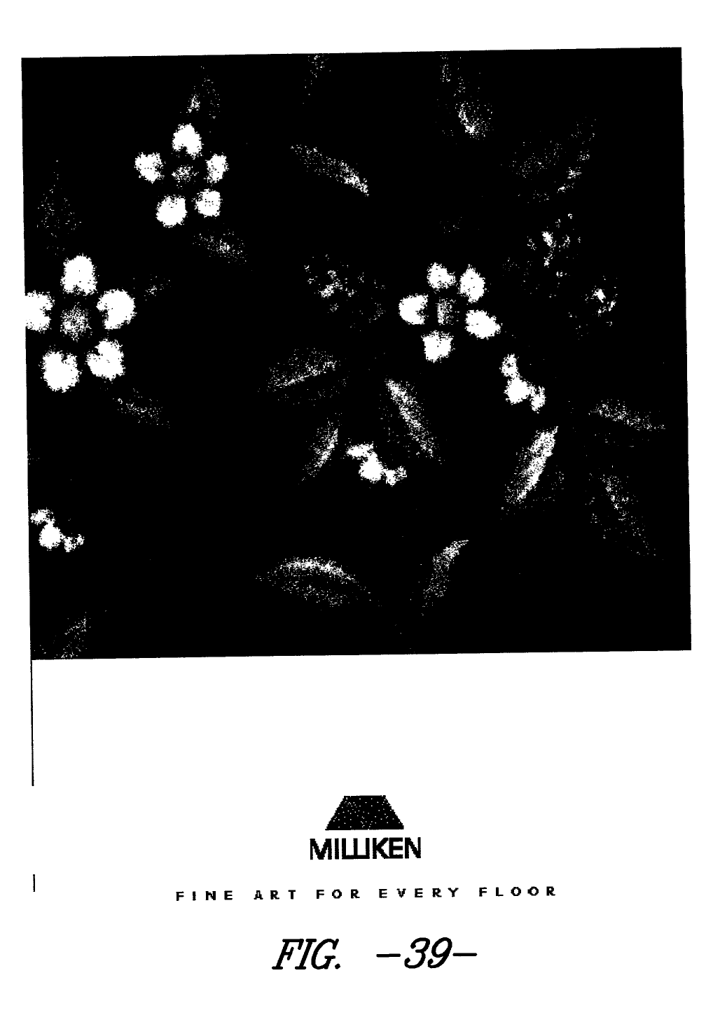

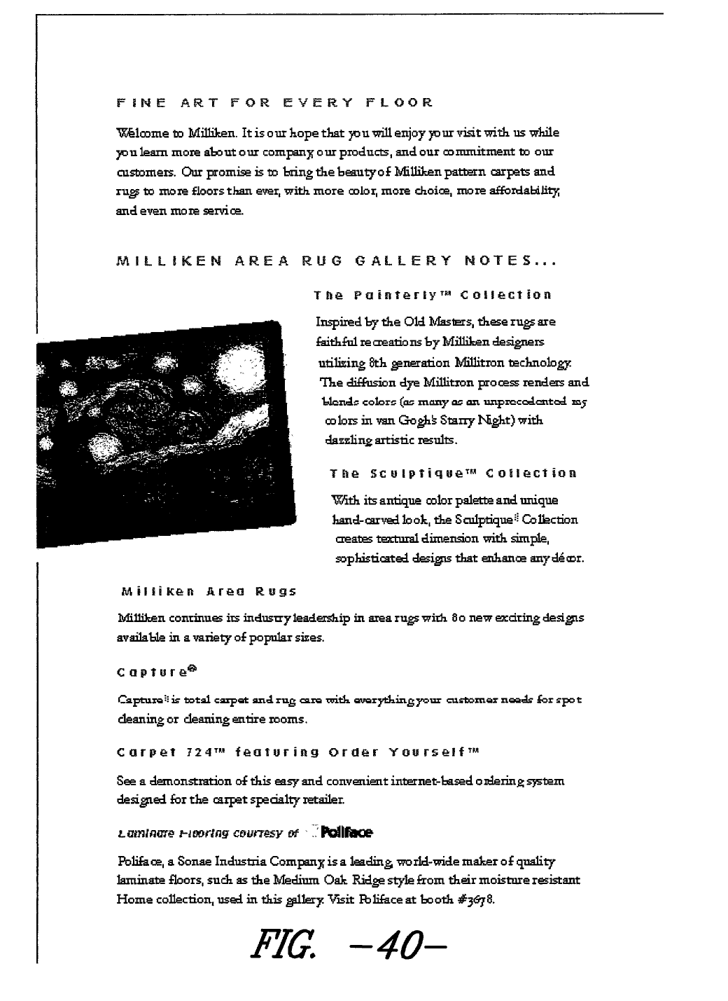

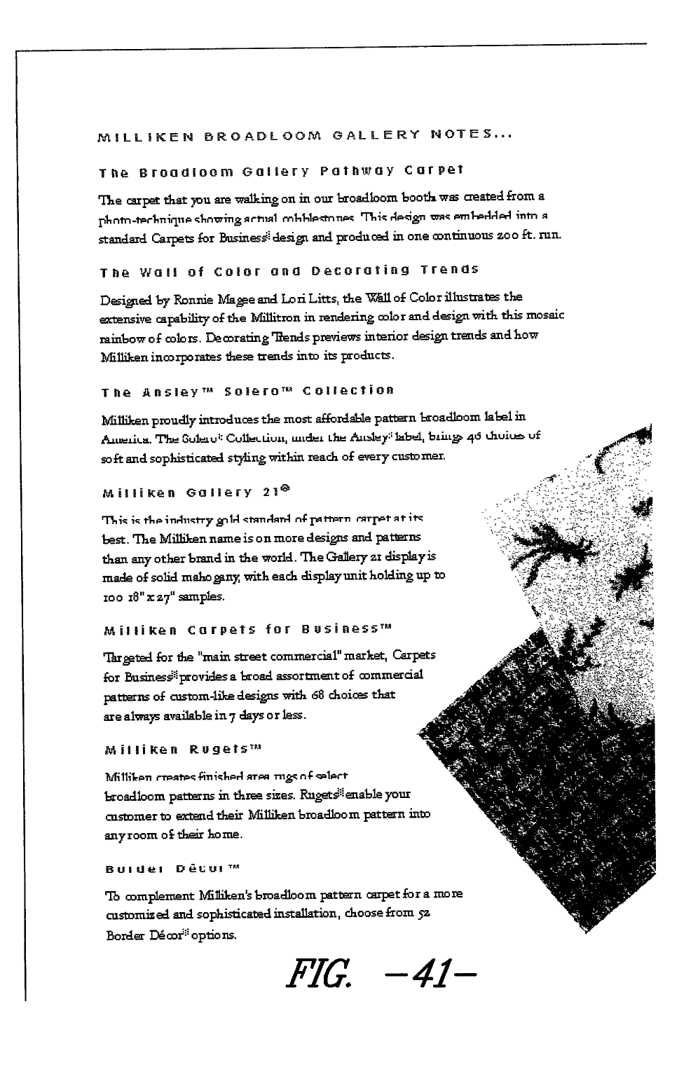

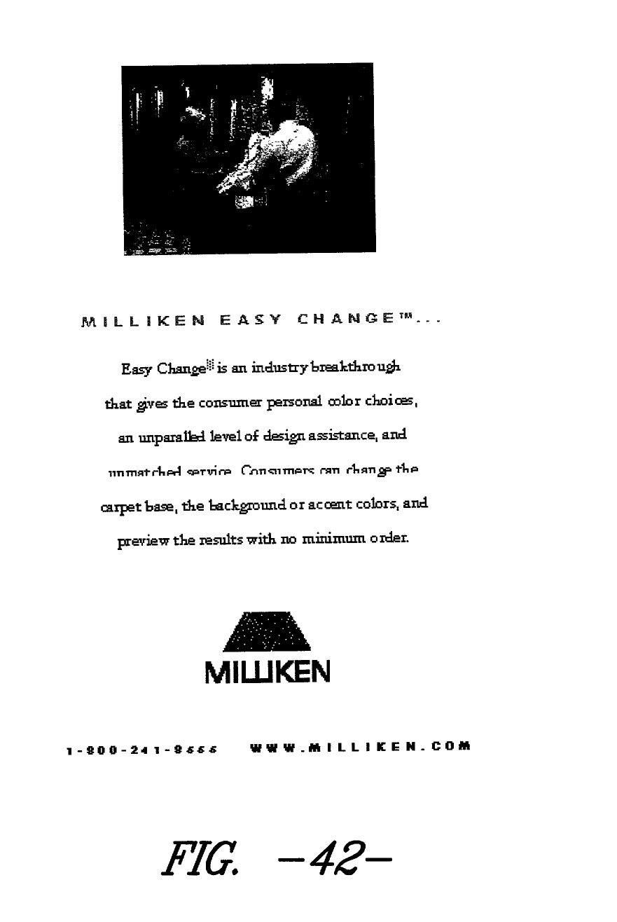

Although FIGS. 3-11 and 12-29 are directed to exemplary depictions of Milliken® Carpets and Rugs Order Entry™ system and method, FIGS. 30-38 are directed to exemplary depictions of Milliken® Sample Studio™ (Commercial Markets Sample Studio) system and method, and FIGS. 39-42 are directed to exemplary depictions of Milliken® promotional information (Milliken is a registered trademark of Milliken & Company), it is to be understood that a particular company can use one or more such websites or that a group of companies may be represented by a single website.

Simplicity of use and performance were key programming concepts behind the design of the layout of the exemplary website of the present invention.

In accordance with a preferred embodiment, a user should be able to fill out an order from an “anchor” page with a minimum number of keystrokes. The final design maintains simplicity by showing as much pertinent information in a single screen as possible. The “anchor” page containing the navigation bar is always visible in the background since no other window launched by the web site is as large as the anchor page. This allows the user to maintain a frame of reference or context in the application instead of getting lost in a myriad of pages or windows arranged in a hierarchy. The main function of the web site —entering orders—is accomplished without much change in the type of content that appears in the sites 3 frames. Only when a user wishes to perform an ancillary function like submit a Quick Claim document, send an email or view promotions is the content type in two of the sites 3 frames changed.

Performance was optimized for the exemplary web site by maintaining JavaScript objects for the current order and current customer. The Current Order and Current Customer objects allow for persistence of the order and customer information to minimize the amount of data that must be retrieved from the mainframe and to localize processing to the web browser. Methods of the Current Order object display the order in process, display the completed order in a new printable window, add a line item, remove a line item, and change a line item in the current object. These persistent objects are stored in the “Home” navigator frame and never change during active usage of the Carpet724 web site.

Agents called by the other Current Order object methods, refresh the entire order object, update the shipping information and complete the order. These agents in turn make updates to the Current Order object and call its methods to display the order and shipping information on the screen.

These persistent objects are stored in the “Home” navigator frame and never change during active usage of the web site.

Agents called by the other Current Order object methods, refresh the entire order object, update the shipping information and complete the order. These agents in turn make updates to the Current Order object and call its methods to display the order and shipping information on the screen.

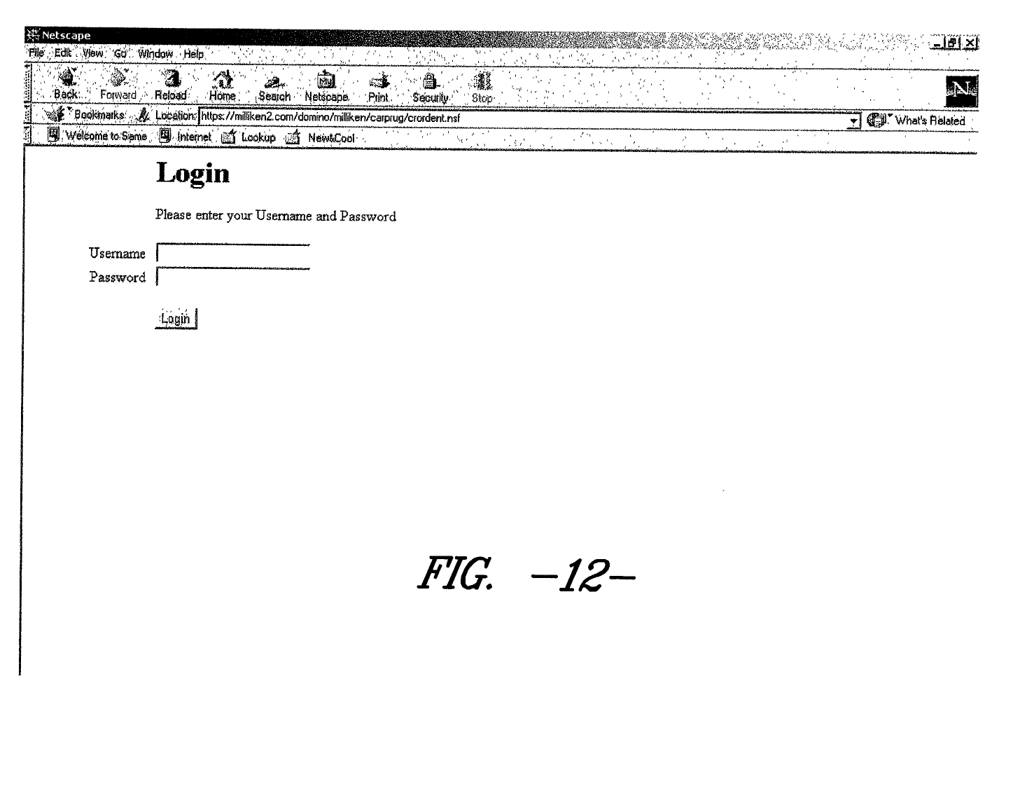

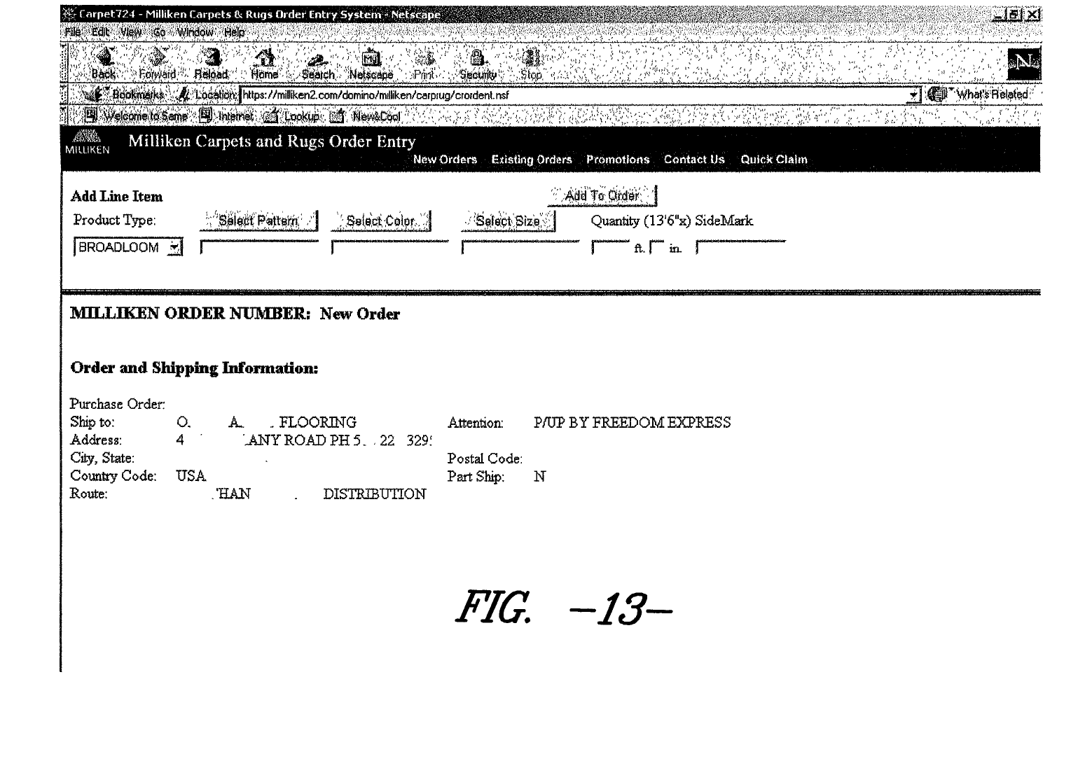

FIGS. 12-29 are directed to another embodiment of the ordering system and method. FIG. 12 depicts a log in screen. FIGS. 13-29 depict the order entry website during sequential steps or phases of order entry.

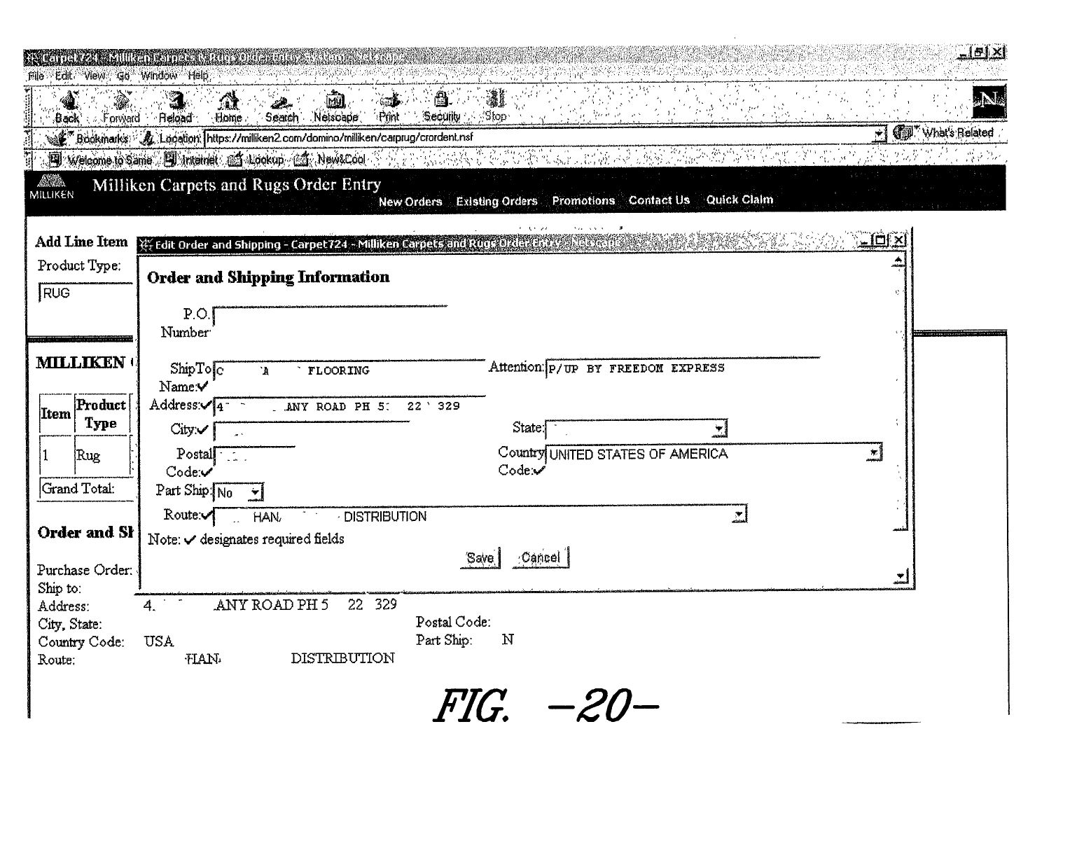

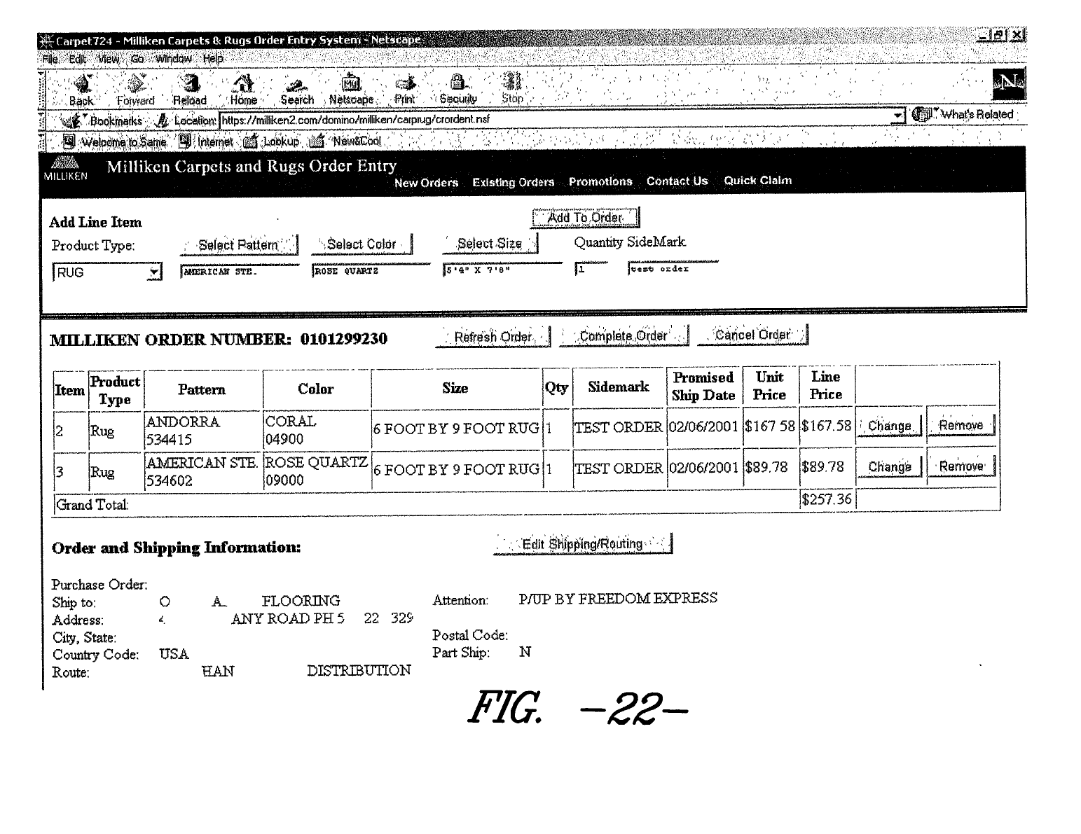

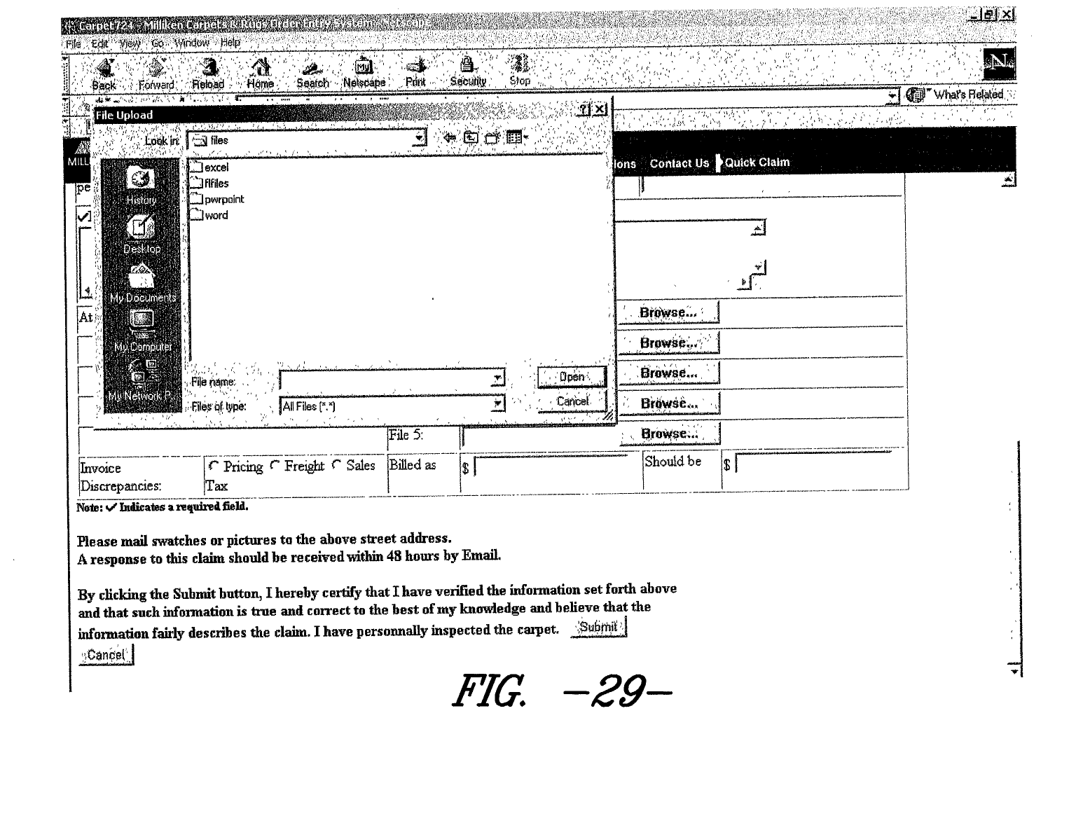

The Edit shipping and routing box is shown in FIG. 20. FIG. 22 shows an option to select from Existing orders and Promotions. On the Quick Claim screen shot of FIG. 29, the user has scrolled down to near the bottom of the screen to allow them to submit pictures of the product that needs to be returned.

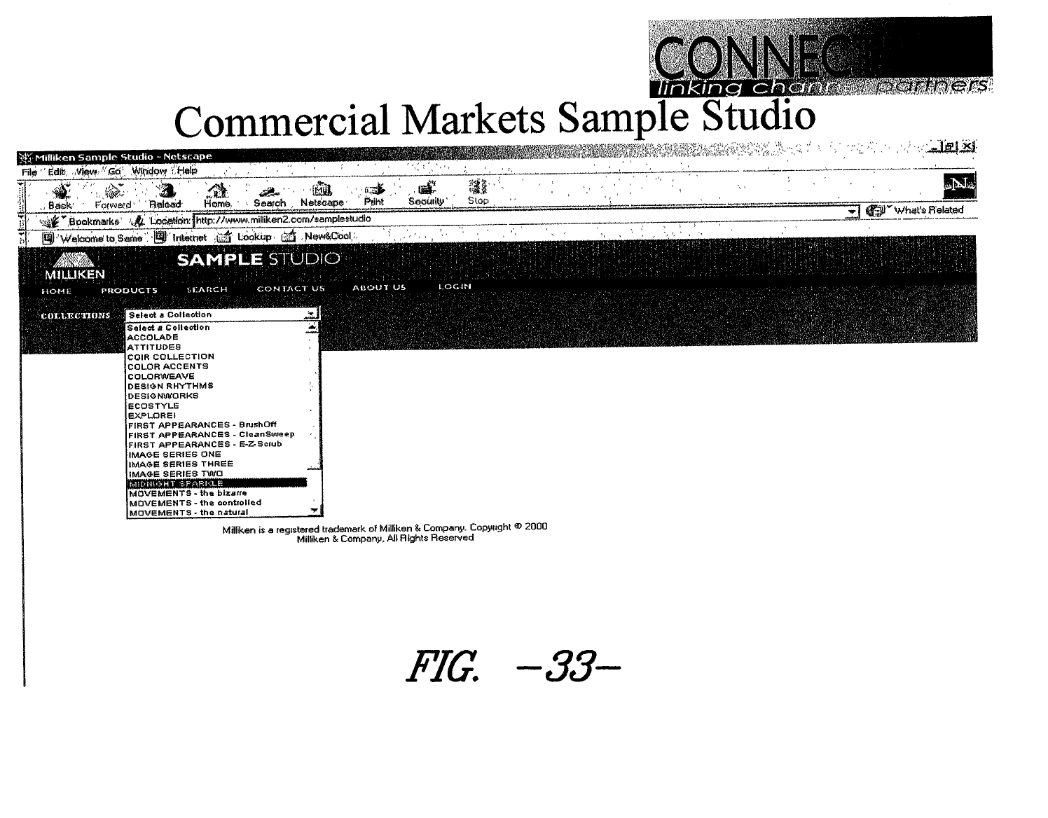

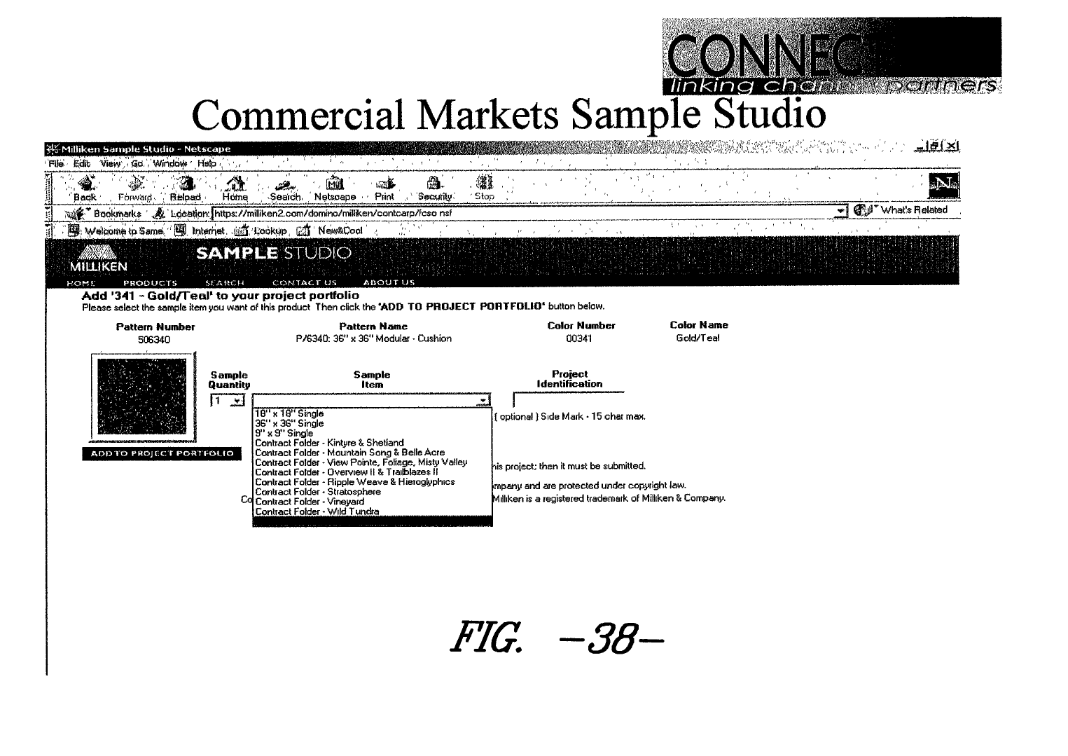

FIGS. 33-37 show screen displays which can be accessed from the ordering website of FIGS. 4-11 or 13-29 or which can be accessed via a separate website such as the Milliken® Sample Studio™ website. This site provides a catalog of images and a search mechanism. It can also have a shopping cart feature like that shown in FIG. 38.

The ordering website may also have shipping tracking information like the UPS number and an on-the-screen link over to the UPS site to allow the user to follow the status of the shipment.

The order entry website of the present invention may also:

1—Provide the ability for the customer to be able to change their password.

2—Provide shipment tracking information—B/Ls for broadloom and UPS tracking number for rugs and Capture® carpet care or cleaning products. Provide a hotlink with this information over to a carrier's site to automatically look up the shipment information and status.

3—Provide catalog functionality with pictures. Separate by type-Broadloom, Rugs, Capture®. Under rugs, provide the sizes it is available in. For broadloom, list the collections. Have a search ability and allow the user to order from there or link over to the form fill site and prepopulate information there.

4—Provide ability to order samples on-line. The samples are preferably on a separate order from production items. Use the same form fill they currently have and have the drop down selection box have a type of sample.

5—Send an email to the customer when the order ships and provide the B/L and/or the UPS tracking number. Can generate one email overnight for multiple orders or just one at a time. Can set up as a customer preference and have an option to turn off the emails if the customer so chooses.

6—Provide a knowledge library ability to provide technical information and specs.

7—Measure how many customers start an order but never complete it.

8—Measure how long is it taking them to enter the order from the start of the 1st product to the completion.

In at least one embodiment, the present invention provides for:

1. Customers enter their own orders.

2. 24 hour access.

3. Real time information status.

Large customers may prefer to use EDI.

In at least one example, Made to Order Products may be over 90% while Inventory Products may be less than 10%.

In one embodiment, the method includes the steps of:

1. Log on to Milliken Carpet website.

2. They will be issued a password (Customer Information).

3. Milliken Web Order Entry System

A. Pick Product Type

B. Pick Pattern

C. Pick Color

D. Pick Size

E. Pick Quality

F. Pick Side Mark (if any)

4. Edit/Change—Select Box and Cascade once make first choice.

5. Continuing List of Products Ordered (Shopping Cart).

6. Remove or Change order item (editable order list).

7. Shipping and Routing Information defaults to Customer Information (distributors can drop ship to their customers).

8. Separate orders to ship to different places.

9. Prices

10. Ship Order Button.

11. Pop Up Window Order Confirmation Information.

12. Print it out.

13. Product/Packing List Installation Instructions.

14. Bill is mailed to order customer

15. View Electronic Catalog

16. Order

In one example, customers are able to go “online” to a carpet company's website and directly enter their orders. This enables them to bypass current order entry procedures and directly enter into system. Customers are able to select:

1. Product Type

2. Pattern

3. Color

4. Size, etc.

5. Quantity

6. Sidemark

7. Shipping Information

There are pop-up windows (or drop down boxes) in each selection category. Once the customer has selected necessary SKU information, then order will be submitted to the carpet company, and a reference number and promise date will be issued back to customer.

This reduces cost of the order entry process, provides order entry conveniences, and reduces errors.

The present invention may reduce or eliminate inventory allocations.

In accordance with at least one embodiment of the present invention, there is provided a floor covering related ordering system and method which enhances or replaces conventional floor covering sales or ordering techniques.

In accordance with at least one embodiment, an ordering system and method utilizes one or more floor covering ordering websites which provide approved customers, potential customers, dealers, distributors, or users an eloquently simple means to review and evaluate current floor covering products, select particular designs or colors, order samples, order product, and the like.

Floor covering products which are produced on demand by, for example, jet dyeing of a pattern or design on a white, colored, or multi-colored base or substrate are especially suited to the method of the present invention.

The manufacture of decorative carpets, rugs, mats, carpet tile, and other textile substrates is performed by weaving, tufting or printing processes using highly specialized machines. One such printing machine is an “automated patterning apparatus” that includes a plurality of programmable color dye jets or ink flow valves that are coordinated to receive precise firing instructions in order to render a patterned image upon the substrate. One such machine implemented by Milliken & Company is known as the “Millitron” and comprises an array or matrix of stationary color dye applicators, each of which provides a flow of dye material that may be interrupted at precise times so that the appropriate amount of dye material may be applied to a moving fibrous pile substrate to accurately render a color pattern thereon. Other machines such as direct jet machines have color dye valves that provide for the direct application of color dyes to the fibrous pile material substrate through the use of one or more sets of dye valves that either are stationary or that traverse across the face of the substrate to be patterned.

The present invention also relates to the manufacture of decorative carpets, rugs, mats, carpet tiles, or other textile material substrates, and particularly to a system and methodology that enables users to select and/or customize a product.

While the invention has been described and disclosed in connection with certain preferred embodiments and procedures, it is by no means intended to limit the invention to such specific embodiments and procedures. Rather it is intended to cover all such alternative embodiments, procedures, and modifications thereto as may fall within the true spirit and scope of the invention. Modifications may be made and other embodiments of the principles of this invention will occur to those skilled in the art to which this invention pertains. Therefore, it is contemplated by the appended claims to cover any such modifications and other embodiments as incorporate the features of this invention within the true spirit and scope thereof.

1. A fully automated floor covering product ordering system comprising an internet website serving as a user interface for direct order entry, for access to floor covering product company designs, patterns, colors, sizes, quantities, prices, or the like, for placing an order, for selecting a ship to location, for selecting a method of payment, for selecting a method of shipment, and the like.

2. The system of claim 1, wherein placing an order includes selecting a product type, pattern, design, color, colors, size, quantity, length, sidemark, sample, product, and combinations thereof.

3. The system of claim 2, wherein product type includes at least one of broadloom carpet, carpet tile, cushion back broadloom carpet, cushion back carpet tile, hardback carpet tile, area rugs, decorative rugs, mats, rugets, runners carpet care products, carpet cleaning products, and combinations thereof.

4. The system of claim 1, wherein the user is selected from the group of customers, dealers, retailers, and distributors.

5. The system of claim 1, wherein the user is at least one of a dealer and distributor who enters the order for a customer.

6. The system of claim 5, wherein the at least one dealer or distributor has the order directly shipped to the customer.

7. The system of claim 1, wherein a user is able to fill out an order from an “anchor” page with a minimum number of keystrokes, the website maintains simplicity by showing as much pertinent information in a single screen as possible, the website includes an “anchor” page containing a navigation bar that is always visible in the background since no other window launched by the web site is as large as the anchor page, this allows the user to maintain a frame of reference or context in the application instead of getting lost in a myriad of pages or windows arranged in a hierarchy, the main function of the web site—entering orders—is accomplished without much change in the type of content that appears in the sites frames, only when a user wishes to perform an ancillary function like submit a Quick Claim document, send an email or view promotions is the content type in two of the sites frames changed, performance for the web site is optimized by maintaining JavaScript objects for the current order and current customer, the Current Order and Current Customer objects allow for persistence of the order and customer information to minimize the amount of data that must be retrieved from the mainframe and to localize processing to the web browser, the Current Order object displays the order in process, displays the completed order in a new printable window, adds a line item, removes a line item, and changes a line item in the current object, these persistent objects are stored in the “Home” navigator frame and never change during active usage of the website, agents called by the other Current Order object methods, refresh the entire order object, update the shipping information and complete the order, these agents in turn make updates to the Current Order object and call its methods to display the order and shipping information on the screen, these persistent objects are stored in the “Home” navigator frame and never change during active usage of the web site.

8. The system of claim 1, wherein the designs and patterns are presented as collections of designs and patterns.

9. The system of claim 1, wherein the designs and patterns are presented in a variety of at least one of colors or color combinations.

10. In a method of manufacturing a floor covering product, the improvement comprising the use of a global internet or world wide web website as a user interface for order entry, order selection, sample ordering, product ordering, direct ship location, method of payment selection, method of shipment selection, making a claim, and combinations thereof.

11. The method of claim 10, wherein order entry includes selecting a product type, pattern, design, color, colors, size, quantity, length, sidemark, sample, product, and combinations thereof.

12. The system of claim 11, wherein product type includes at least one of broadloom carpet, carpet tile, cushion back broadloom carpet, cushion back carpet tile, hardback carpet tile, area rugs, decorative rugs, rugs, mats, rugets, runners, carpet care products, carpet cleaning products, and combinations thereof.

13. The system of claim 10, wherein the user is selected from the group of customers, dealers, retailers, and distributors.

14. An automated floor covering product ordering system comprising at least one global internet or world wide web website or home page which serves as a customer interface for gaining approval as a customer, reviewing and selecting samples or products, selecting a ship to location, selecting a mode of payment, selecting a delivery schedule, and thereby ordering one or more floor covering products or samples from one or more companies, warehouses, factories, plants, and combinations thereof.

15. An adjunct to an automated floor covering production system comprising at least one Internet or world wide web website or home page which allows for customer direct order entry, product selection, ship to location, payment method, delivery schedule, and combinations thereof.

16. The system of claim 15, wherein order entry includes selecting a product type, pattern, design, color, colors, size, quantity, length, sidemark. sample, product, and combinations thereof.

17. The system of claim 16, wherein product type includes at least one of broadloom carpet, carpet tile, cushion back broadloom carpet, cushion back carpet tile, hardback carpet tile, area rugs, decorative rugs, rugs, mats, rugets, runners, carpet care products, carpet cleaning products, and combinations thereof.

18. An ordering system or method for reducing inventory needs and costs, comprising an automated floor covering product ordering system comprising at least one global internet or world wide web website or home page which serves as a customer interface for gaining approval as a customer, reviewing and selecting samples or products, selecting a ship to location, selecting a mode of payment, selecting a delivery schedule, and thereby ordering one or more floor covering products or samples from one or more companies, warehouses, factories, plants, and combinations thereof.

19. A fully automated floor covering ordering method comprising the steps of selecting a product type, color, quantity, size, ship to location, and payment method.

20. In a floor covering ordering system, the improvement comprising a secure direct order entry website.

21. In a floor covering ordering method, the improvement comprising utilization of a secure ordering website.

22. A cost efficient method of producing an on demand or a custom or special floor covering product or sample, comprising providing an automated floor covering product ordering system including at least one global internet or world wide web website or home page which serves as a customer interface for gaining approval as a customer, reviewing and selecting samples or products, selecting a ship to location, selecting a mode of payment, selecting a delivery schedule, and thereby ordering one or more floor covering products or samples from one or more companies, warehouses, factories, plants, and combinations thereof.

23. An environmentally friendly method of producing floor covering and eliminating waste, comprising providing an automated floor covering product ordering system including at least one global internet or world wide web website or home page which serves as a customer interface for gaining approval as a customer, reviewing and selecting samples or products, selecting a ship to location, selecting a mode of payment, selecting a delivery schedule, and thereby ordering one or more floor covering products or samples from one or more companies, warehouses, factories, plants, and combinations thereof.

24. A floor covering product ordered by the system of claim 1.

25. A floor covering product produced by the method of claim 10.

26. A floor covering product ordered by the system of claim 14.

27. A floor covering product produced by the method of claim 19.

28. The product as recited in claim 24, wherein the product is jet dyed.

29. The product as recited in claim 24, wherein the product is produced on demand.

30. The product as recited in claim 25, wherein the product is jet dyed.

31. The product as recited in claim 25, wherein the product is produced on demand.

32. The product as recited in claim 26, wherein the product is jet dyed.

33. The product as recited in claim 26, wherein the product is produced on demand.

34. The product as recited in claim 27, wherein the product is jet dyed.

35. The product as recited in claim 27, wherein the product is produced on demand.
